(19) United States
(12) Patent Application Publication
(10) Pub. No.: US 2013/0142060 A1
(43) Pub. Date: Jun. 6, 2013

(54) INSTANTANEOUS NOISE NORMALIZED SEARCHER METRICS

(71) Applicants: Raghu Narayan Challa, San Diego, CA (US); Shivratna Giri Srinivasan, San Diego, CA (US)

(72) Inventors: Raghu Narayan Challa, San Diego, CA (US); Shivratna Giri Srinivasan, San Diego, CA (US)

(73) Assignee: QUALCOMM INCORPORATED, San Diego, CA (US)

(21) Appl. No.: 13/581,046

(22) PCT Filed: Feb. 28, 2011
(86) PCT No.: PCT/US11/26531

§ 371 Date: Sep. 24, 2012

Related U.S. Application Data
(60) Provisional application No. 61/308,796, filed on Feb. 26, 2010.

(51) Int. Cl. H04J 3/06; H04J 1/16; H04J 4/00

(52) U.S. Cl. CPC H04J 3/0608; H04J 4/00; H04J 1/16
USPC 370/252; 370/350

(57) ABSTRACT

In a wireless communication system employing frequency division duplexing (FDD) that may be synchronous or asynchronous for transmitting data, in which the underlying Rx signals have different statistics, and where the hypothesis testing is degraded thereby, the improvement of generating a complementary searcher metric that is a noise metric (NM) comprising: projecting the Rx signals into the noise subspace of a pilot sequence.

### CLAIM OF PRIORITY

The present application for Patent claims priority to Provisional Application No. 61/308,796 entitled Instantaneous Noise Normalized Searcher Metrics filed Feb. 26, 2010, and assigned to the assignee hereof and hereby expressly incorporated by reference herein.

### BACKGROUND

I. Field

The present invention relates generally to searching for pilot sequences during initial acquisition and during tracking in a wireless telecommunications system. More specifically, the present invention relates to generating a complementary searcher metric, hereafter referred to as a “noise metric” (NM) to overcome degraded hypothesized pilot sequences with the received data that are degraded if the received signals or samples (Rx) are non-stationary such as in Time-Division Duplex (TDD) systems, where the window may be comprised of both downlink (DL) and uplink (UL) samples that can be over a wide dynamic range.

II. Background

In a majority of wireless systems a searcher searches for pilot sequences during initial acquisition and during tracking Typically searcher metrics are generated across a window of time and sorted to declare winner(s) that have the highest energy. The searcher metrics are generated by correlating the hypothesized pilot sequences with the received data to generate “energy metrics” (EM). However, hypothesis test will be degraded if the received samples are non-stationary such as in Time Division Duplex (TDD) systems where the window may comprise both downlink (DL) and uplink (UL) samples that can be over a wide dynamic range.

Because the underlying Rx samples have different statistics, the hypothesis testing is significantly degraded. This is most obvious in a TDD system during initial acquisition, where the searcher does not know if the hypothesis is generated from DL samples or UL samples that can be as much as 100 dB apart.

In wireless communications Code Division Multiple Access (CDMA) voice systems fast automatic gain control (AGC) achieves some resolution of degraded correlation of hypothesis test indirectly; however, AGC is not applicable to data systems due to bursty non-continuous pilots.

There is a need in the art of searching for pilot sequences during initial acquisition and during tracking in a wireless telecommunication system to generate energy metrics (EM) by correlating the hypothesized pilot sequences where the CDMA is not a voice system, but instead, a data system that produces bursty non-continuous pilots.

### SUMMARY

In a wireless communication system employing CDMA for data systems, in which the underlying Rx signals have different statistics, and where the hypothesis testing is significantly degraded, it is one aspect of the current innovation to generate a complementary searcher metric, hereafter referred to as a “noise metric” (NM) by projecting the Rx signals into the noise subspace of the pilot sequence.

Another aspect of the current innovation is the recognition that an important property of the NM is that it is generated from the same set of Rx samples used to generate EM, and thereby shares the same statistics (i.e. gain scaling arising out of power variations in the Rx samples).

A yet further aspect of the current innovation is the advancement of a new searcher metric as the EM divided by the “noise metric” (NM) that effectively cancels out the power variations and restores the accuracy of the hypothesis test.

The foregoing and other aspects of the current innovation will become more apparent by reference to the Brief Description of The Drawings and Detailed Description.

### BRIEF DESCRIPTION OF THE DRAWINGS

FIG. 1 is a graph showing detection probability verses Secondary Synchronization Signal (SSS) detection probabilities for different Primary Synchronization Signal (PSS) detection rules.

FIG. 2 is a graph showing SSS detection probability verses SNR (dB), wherein the lower red-curve shows how probability of detection becomes 0 with legacy searcher implementations in a Time Division Duplex (TDD) multi plexing system to separate outward and return signals, and wherein the upper or blue-curve shows how the present innovation restores the performance to its full level.

FIG. 3 is a graph showing SSS detection probability with 3 dB boost for uplink relative to downlink.

FIG. 4 is a graph showing SSS detection probability with 10 dB boost for uplink relative to downlink.

FIG. 5 is a graph showing SSS detection probability with 26 dB boost for uplink relative to downlink.

FIG. 6 is a graph showing correlation between PSS sequences with indices 25, 29.

FIG. 7 is a graph showing correlation between PSS sequences with indices 25, 34.

FIG. 8 is a graph showing correlation between PSS sequences with indices 29, 34.

FIG. 9 is a graph showing periodic cross correlations between PSS sequences 25 and 29 at different time offsets.

FIG. 10 is a graph showing periodic cross correlations between PSS sequences 25 and 34 at different time offsets.

FIG. 11 is a graph showing periodic cross correlations between PSS sequences 29 and 34 at different time offsets.

FIG. 12 is a graph showing a periodic cross correlations between PSS sequences 25 and 29 at different time offsets.

FIG. 13 is a graph showing a periodic cross correlations between PSS sequences 25 and 34 at different time offsets.

FIG. 14 is a graph showing a periodic cross correlations between PSS sequences 29 and 34 at different time offsets.

FIG. 15 is a graph showing a plot of LHS and RHS of equation 1.32.

FIG. 16 is a graph showing correlation between PSS/PSS and effective PSS/PSS, for indices 25, 25.

FIG. 17 is a graph showing correlation between PSS/PSS and effective PSS/PSS, at indices 25, 29.

FIG. 18 is a graph showing correlation between PSS/PSS and effective PSS/PSS, at indices 25, 34.

FIG. 19 is a graph showing correlation between PSS/PSS and effective PSS/PSS, at indices 29, 25.

FIG. 20 is a graph showing correlation between PSS/PSS and effective PSS/PSS, for indices 29, 29.

FIG. 21 is a graph showing correlation between PSS/PSS and effective PSS/PSS, at indices 29, 34.

FIG. 22 is a graph showing correlation between PSS/PSS and effective PSS/PSS, at indices 34, 25.

FIG. 23 is a graph showing correlation between PSS/PSS and effective PSS/PSS, at indices 34, 29.

FIG. 24 is a graph showing correlation between PSS/PSS and effective PSS/PSS, at indices 34, 34; and

FIG. 25 is a graph showing cross correlations of SSS sequence against other SSS sequences with the same PSS index.

FIG. 26 is a diagram illustrating a use the searcher metric as implemented by a processor.

### DETAILED DESCRIPTION

### Exemplary

A searcher is used in the majority of wireless systems to search for pilot sequences during initial acquisition and during tracking The searcher metrics are generated across a window of time and sorted to declare winner(s) that have the highest energy. Typically the searcher metrics are generated by simply correlating the hypothesized pilot sequences with the received data to generate “energy metrics” (EM). However, the hypothesis test will be degraded if the received samples are non-stationary such as in TDD systems where the window may be comprised of both DL and UL samples that can be over a wide dynamic range.

When the underlying Rx samples have different statistics, the hypothesis testing is significantly degraded. This is most obvious in a TDD system during initial acquisition where the searcher does not know if the hypothesis is generated from DL samples or UL samples, as they can be as much as 100 dB apart. Simulations show that the searcher performance degrades rapidly with as little as a 3 dB power difference.

The present innovation solves this problem by generating a complementary searcher metric called “noise metric” (NM) by projecting the Rx samples into the noise subspace of the pilot sequence. An important property of this NM is that it is generated from the same set of Rx samples used to generate EM and hence shares the same statistics (i.e. gain scaling arising out of power variations in Rx samples).

Changes need to be made to searcher algorithms for frequency division duplexing (FDD), so that they apply to the time division duplexing (TDD) mode. These changes primarily pertain to initial acquisition. In the TDD mode, there may be finer changes to a neighbor search that depend on higher layer specifications.

The TDD deployments are likely to be synchronous, while FDD deployments can be either synchronous or asynchronous. The changes to the searcher benefit both 1) the TDD requirements and 2) synchronous deployments.

In TDD mode, prior to initial acquisition, uplink (UL) and downlink (DL) subframe boundaries are unknown. Therefore timing detection algorithms need to account for the large power difference between UL and DL transmissions, which could result in false alarms without appropriate normalizations to the searcher metric. Another issue is that in synchronous networks, synchronization signals could collide, which could result in interference, false alarms and a strong cell transmission could hide a weaker colliding cell. Therefore, interference cancellation is required during timing detection to mitigate the above-mentioned problems.

This innovation addresses six topics:
1) Noise normalization in PSS/Timing detection;
2) Noise normalization in SSS detection;
3) Coherent combining of SSS followed by non-coherent detection;
4) PSS collision zero forcing and modified zero forcing algorithms;
5) Searcher issues in TDD; and
6) Implementation changes from Frequency Division duplexing (FDD).

### PSS/Timing Detection

In LTE, initial acquisition of timing is performed using the primary synchronization signal (PSS). This is followed by acquisition of a secondary synchronization signal (SSS) which is generally used to obtain radio frame timing and cell group identification information. For each possible timing hypothesis, the received samples are correlated against the reference sequence and a correlation peak indicates a symbol boundary of the PSS.

If the noise across both Rx antennas have the same average powers (and are stationary and ergodic), equal weight noncoherent combining of the correlations across Rx antennas is indicated by the maximum likelihood (ML) detection rule. This is assuming a-priori that the channel fading and additive noise is independent and identically distributed (i.i.d.) across Rx antennas.

In TDD mode, prior to initial acquisition, uplink (UL) and downlink (DL) subframe boundaries are unknown. Therefore timing detection algorithms need to account for the large power difference between UL and DL transmissions, which could result in false alarms without appropriate normalizations to the searcher metric.

Another scenario is when the noise across Rx antennas is independent but not identically distributed. In this scenario, the noise variance can be estimated using the PSS and suitable normalizations can be applied while detecting the PSS. Note that MRC combining across Rx antennas pertains to the coherent detection case. A natural question that arises is how should the PSS correlations across Rx antennas be non-coherently combined.

Clearly, the frame boundaries are not known until initial acquisition is complete. In the case of time division duplexing (TDD), this implies that the uplink and downlink subframes are also unknown during initial acquisition. Since the uplink and downlink transmission powers could be very different, correlating the PSS without some normalization could give rise to false alarms, i.e. correlation peaks that are due to an uplink signal being transmitted from a neighbor UE with large power are mistaken for a PSS transmitted from the downlink. Another undesirable scenario that could occur is a strong bared cell hiding a weaker non-bared cell. The analysis and results also address the above problem, by identifying the right normalization during PSS detection.

### Noise Estimation

For simplicity, we first describe how to estimate the noise variance and detect the PSS sequence at the right timing. Again for simplicity, we assume single path fading.

Denote the PSS sequence by the vector x ε [symbol] . Let the received sequence be y ε␣^{64×1}, which is extracted from the true timing. For simplicity, we consider a system with 2 Rx antennas (the results here can be easily extended). Then the received sequence across Rx antenna i after undergoing fading with coefficient hᵢ ε [symbol] and additive noise nᵢ ε□^{64×1} is given by

yᵢ=hᵢx+nᵢ, i=1,2 (1.1)

representing “a function of.”

For simplicity, we omit the subscript on the received sequence yᵢ while describing noise estimation. In order to estimate the noise from the received sequence, we need to null out the signal term. This is accomplished by using the projection matrix

$$E = I - \frac{{xx}^{*}}{{‖ x ‖}^{2}} ,$$

which is the matrix whose columns span the space orthogonal to x. In short, an estimate of the noise vector n is Ey. Note that

$$Ey = y - x \frac{{x}^{*} y}{{‖ x ‖}^{2}}$$

is also the first residual vector obtained during the classical Gram-Schmidt orthogonalization procedure when x is chosen as one of the basis vectors. Note that since E is a projection matrix, E²=E.

Therefore, when N is the dimension of the sequences x and y, an estimate of the variance of the noise is:

$$\begin{matrix}{{σ}^{•}}^{2} = \frac{1}{N - 1} 〈 Ey , Ey 〉 \\ = \frac{1}{N - 1} {y}^{*} {E}^{*} Ey \\ = \frac{1}{N - 1} ( {y}^{*} y - \frac{{\vert {x}^{*} y \vert}^{2}}{{‖ x ‖}^{2}} )\end{matrix} \qquad ( 1.2 )$$

PSS/Timing Detection with Noise Normalization

Having estimated the noise, we need to detect one out of 3 PSS sequences. We make the assumption that the fading coefficients hᵢ and noise nᵢ across different antennas are independent (worst case assumption). The ML detection rule then is:

\hat{k}=arg maxₓp(y₁, y₂|x) (1.3)

In equation (1.3), the sequence x refers to one of the PSS sequences. The following equation represents the received signal for both Rx antennas:

$$\underbrace{[ \begin{matrix}{y}_{1} \\ {y}_{2}\end{matrix} ]}_{y} = \underbrace{[ \begin{matrix}{xh}_{1} \\ {xh}_{2}\end{matrix} ]}_{s} + \underbrace{[ \begin{matrix}{n}_{1} \\ {n}_{2}\end{matrix} ]}_{n} \qquad ( 1.4 )$$

We assume that n₁ □ Cη(0, σ₁²I), n₂ [symbol] Cη(0, σ₂²I), h₁ □ Cη(0, a₁) and h₂ □ Cη(0, a₂). We also assume that all random variables mentioned above are independent. In the following derivation, we treat a₁ and a₂ as nuisance parameters, and derive the generalized maximum likelihood detection rule (also known as the generalized likelihood ratio test [GLRT]). Let Σ be the noise covariance matrix. The conditional probability density function (pdf) of the received signal y given the transmitted signal x can be written as:

$$\begin{matrix}p ( y \vert x ) = \frac{1}{det ( \sum + E [ {ss}^{*} ] )} exp ( - {{y}^{*} ( \sum + E [ {ss}^{*} ] )}^{- 1} y ) \\ = \frac{1}{det ( [ \begin{matrix}{σ}_{1}^{2} I & 0 \\ 0 & {σ}_{2}^{2} I\end{matrix} ] + [ \begin{matrix}{a}_{1} {xx}^{*} & 0 \\ 0 & {a}_{2} {xx}^{*}\end{matrix} ] )} \\ exp ( - {{y}^{*} ( [ \begin{matrix}{σ}_{1}^{2} I & 0 \\ 0 & {σ}_{2}^{2} I\end{matrix} ] + [ \begin{matrix}{a}_{1} {xx}^{*} & 0 \\ 0 & {a}_{2} {xx}^{*}\end{matrix} ] )}^{- 1} y )\end{matrix} \qquad ( 1.5 )$$

The generalized ML rule is:

\hat{x}=arg maxₓ max_{{a}_{₁}_{, a}_{₂}_{}}p(y|x) (1.6)

The generalized ML rule is therefore equivalent to:

$$\begin{matrix}\hat{x} = arg {min}_{x} {min}_{\{ {a}_{1} , {a}_{2} \}} {( {σ}_{1}^{2} I + {a}_{1} {xx}^{*} )}^{- 1} {y}_{1} + {{y}_{2}^{*} ( {σ}_{2}^{2} I + {a}_{2} {xx}^{*} )}^{- 1} {y}_{2} \\ = arg {min}_{x} {min}_{\{ {a}_{1} , {a}_{2} \}} [ {y}_{1}^{*} \{ {σ}_{1}^{- 2} I - {σ}_{1}^{- 2} {a}_{1} {x ( 1 + {a}_{1} {x}^{*} x {σ}_{1}^{- 2} )}^{- 1} {σ}_{1}^{- 2} {x}^{*} \} {y}_{1} + \\ {y}_{2}^{*} \{ {σ}_{2}^{- 2} I - {σ}_{2}^{- 2} {a}_{2} {x ( 1 + {a}_{2} {x}^{*} x {σ}_{2}^{- 2} )}^{- 1} {σ}_{2}^{- 2} {x}^{*} \} {y}_{2} ] \\ = arg {max}_{x} {max}_{\{ {a}_{1} , {a}_{2} \}} \frac{{a}_{1} {\vert {x}^{*} {y}_{1} \vert}^{2}}{( {σ}_{1}^{2} + {a}_{1} {x}^{*} x ) {σ}_{1}^{2}} + \frac{{a}_{2} {\vert {x}^{*} {y}_{2} \vert}^{2}}{( {σ}_{2}^{2} + {a}_{2} {x}^{*} x ) {σ}_{2}^{2}} \\ = arg {max}_{x} \frac{{\vert {x}^{*} {y}_{1} \vert}^{2}}{{‖ x ‖}^{2} {σ}_{1}^{2}} + \frac{{\vert {x}^{*} {y}_{2} \vert}^{2}}{{‖ x ‖}^{2} {σ}_{2}^{2}}\end{matrix} \qquad ( 1.7 )$$

Note that in equation (0.1) we have applied the Woodbury's identity for matrix inversion

(A+BCD)⁻¹=A⁻¹−A⁻¹B(C⁻¹+DA⁻¹B)⁻¹DA⁻¹ (1.8)

When ∥x∥=1, Equation (0.1) is essentially the following detection rule

$$arg {max}_{x} \frac{{\vert {x}^{*} {y}_{1} \vert}^{2}}{{σ}_{1}^{2}} + \frac{{\vert {x}^{*} {y}_{2} \vert}^{2}}{{σ}_{2}^{2}} \qquad ( 1.9 )$$

When we substitute estimates for the noise variances, the detection rule simply becomes

$$arg {max}_{x} \frac{{\vert {x}^{*} {y}_{1} \vert}^{2}}{\frac{1}{N - 1} ( {y}_{1}^{*} {y}_{1} - {\vert {x}^{*} {y}_{1} \vert}^{2} )} + \frac{{\vert {x}^{*} {y}_{2} \vert}^{2}}{\frac{1}{N - 1} ( {y}_{2}^{*} {y}_{2} - {\vert {x}^{*} {y}_{2} \vert}^{2} )} \qquad ( 1.10 )$$

Note that we have assumed ∥x∥=1 in (1.10). For HW simplicity, since the PSS sequences at oversampling rate (OSR) 1 are of length N=64, we may approximate N−1 in (1.10) by 64 and evaluate the division by a 6 bit-shift.

To evaluate the detection metric obtained in (1.10), we simulate the entire searcher with and without the detection metric in (1.10). More specifically, we compare the detection probabilities of the secondary synchronization signal (SSS), when the PSS/Timing detection algorithm uses one of three normalizations:

$$\begin{matrix}1 ) No Normalization \\ {arg {max}_{x}}_{Over multiple time hypotheses of data y} {\vert {x}^{*} {y}_{1} \vert}^{2} + {\vert {x}^{*} {y}_{2} \vert}^{2} & ( 1.11 ) \\ 2 ) Normalization 1 \\ {arg {max}_{x}}_{Over multiple time hypotheses of data y} \frac{{\vert {x}^{*} {y}_{1} \vert}^{2}}{\frac{1}{N - 1} ( {y}_{1}^{*} {y}_{1} - {\vert {x}^{*} {y}_{1} \vert}^{2} )} + \frac{{\vert {x}^{*} {y}_{2} \vert}^{2}}{\frac{1}{N - 1} ( {y}_{2}^{*} {y}_{2} - {\vert {x}^{*} {y}_{2} \vert}^{2} )} & ( 1.12 ) \\ 3 ) Normalization 2 \\ {arg {max}_{x}}_{Over PSS indices and multiple time hypotheses of data y} \frac{{\vert {x}^{*} {y}_{1} \vert}^{2}}{{‖ {y}_{1} ‖}^{2} ( {y}_{1}^{*} {y}_{1} - {\vert {x}^{*} {y}_{1} \vert}^{2} )} + \frac{{\vert {x}^{*} {y}_{2} \vert}^{2}}{{‖ {y}_{2} ‖}^{2} ( {y}_{2}^{*} {y}_{2} - {\vert {x}^{*} {y}_{2} \vert}^{2} )} & ( 1.13 )\end{matrix}$$

Other alternatives are as follows (not simulated)

$$\begin{matrix}4 ) Normalization 3 \\ {arg {max}_{x}}_{Over multiple time hypotheses of data y} \frac{{\vert {x}^{*} {y}_{1} \vert}^{2}}{{‖ {y}_{1} ‖}^{2}} + \frac{{\vert {x}^{*} {y}_{2} \vert}^{2}}{{‖ {y}_{2} ‖}^{2}} & ( 1.14 ) \\ 5 ) Normalization 4 \\ {arg {max}_{x}}_{Over multiple time hypotheses of data y} \frac{{\vert {x}^{*} {y}_{1} \vert}^{2}}{{E}_{1}} + \frac{{\vert {x}^{*} {y}_{2} \vert}^{2}}{{E}_{2}} & ( 1.15 )\end{matrix}$$

Where E1 and E2 are average energy estimates obtained by averaging energies derived using a subset of time hypotheses of the data from Rx antenna 1 and Rx antenna 2. This may be thought of as slow normalization (rather than fast instantaneous normalization as adopted in 1.12 and 1.14.

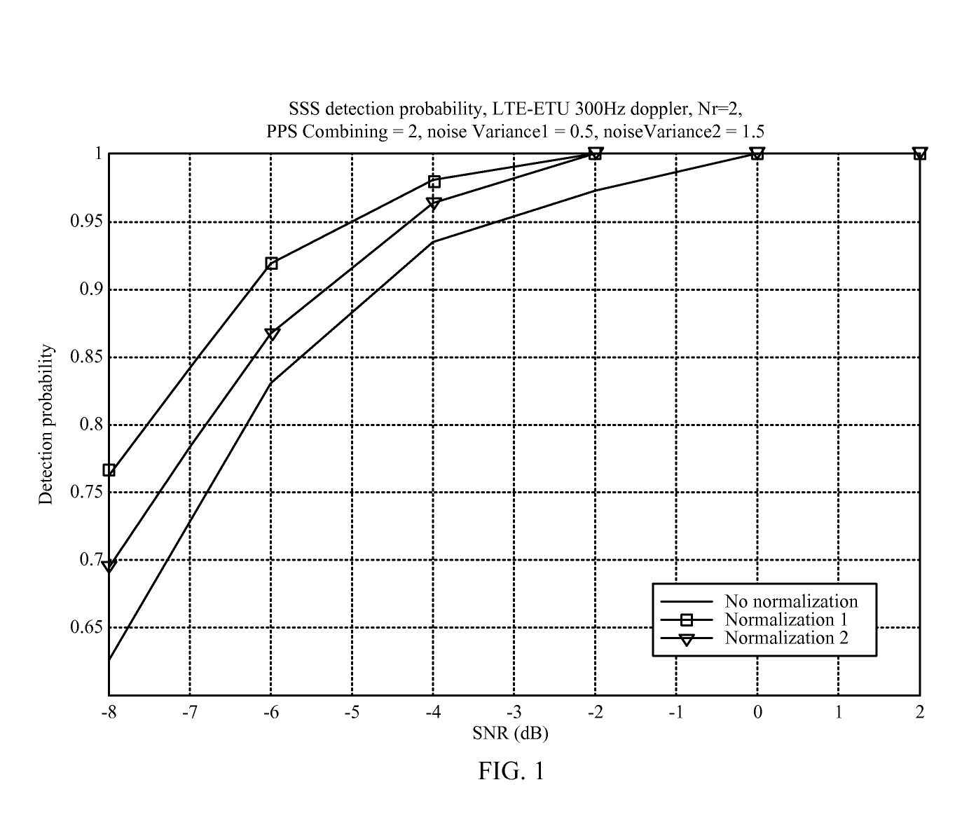

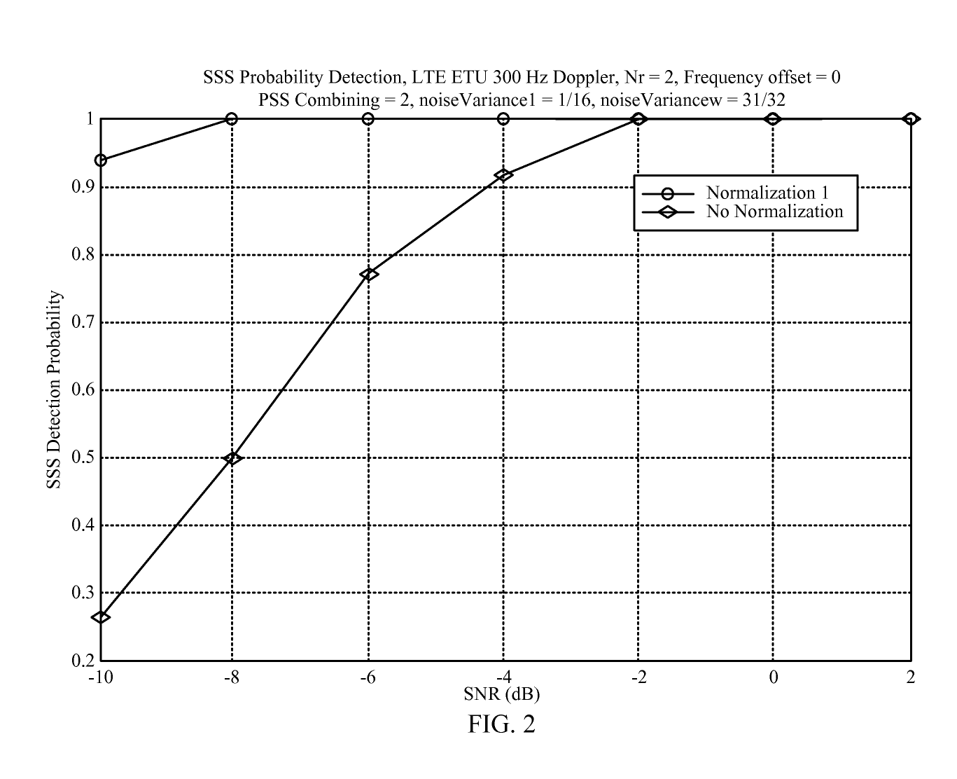

We assume a noise variance of 0.5 in antenna 1 and a noise variance of 1.5 in antenna 2, and consider an ETU channel with Doppler of 300 Hz. FIG. 1 and FIG. 2 demonstrating the substantial gains possible by normalizing the per-antenna noncoherent decision metrics appropriately.

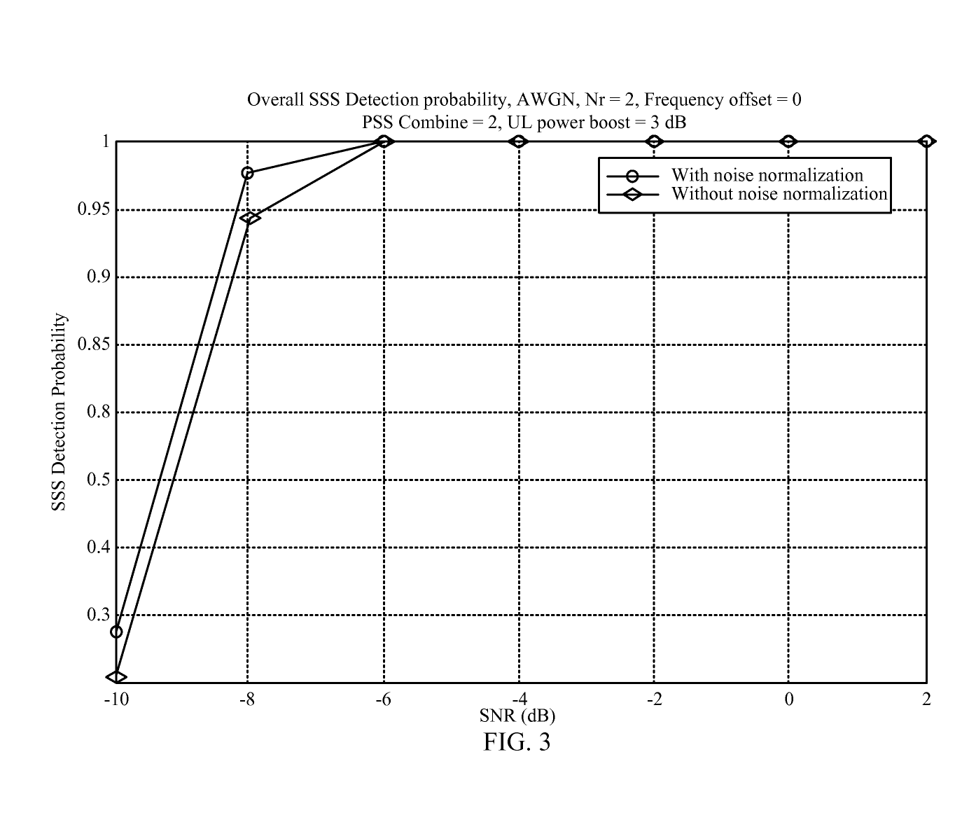

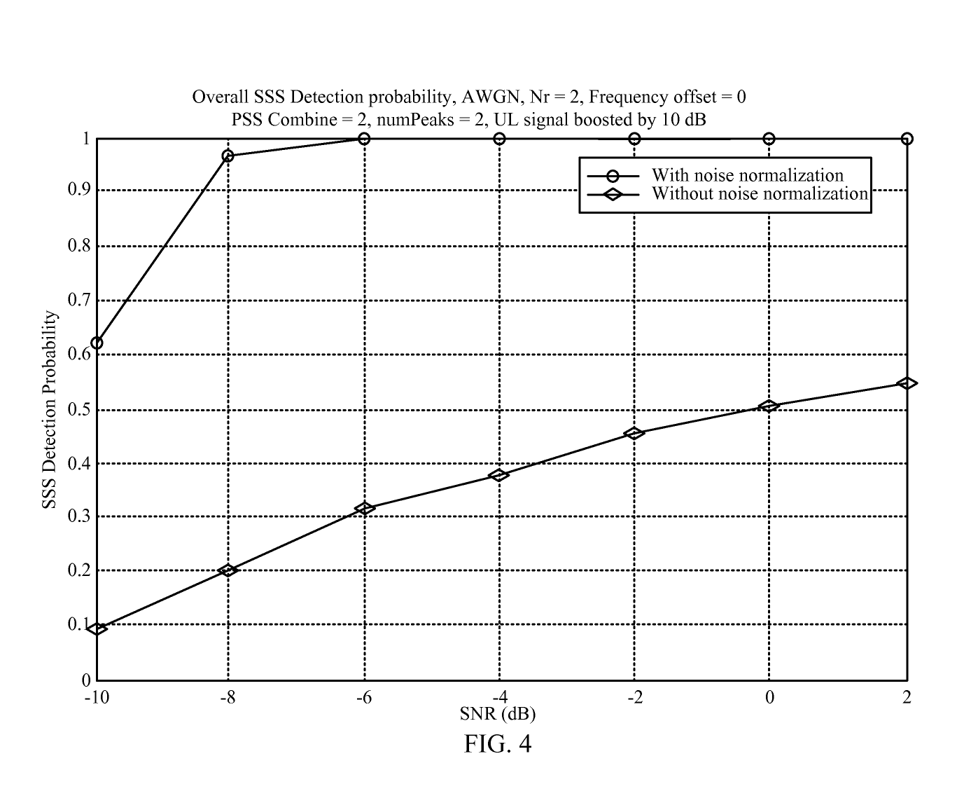

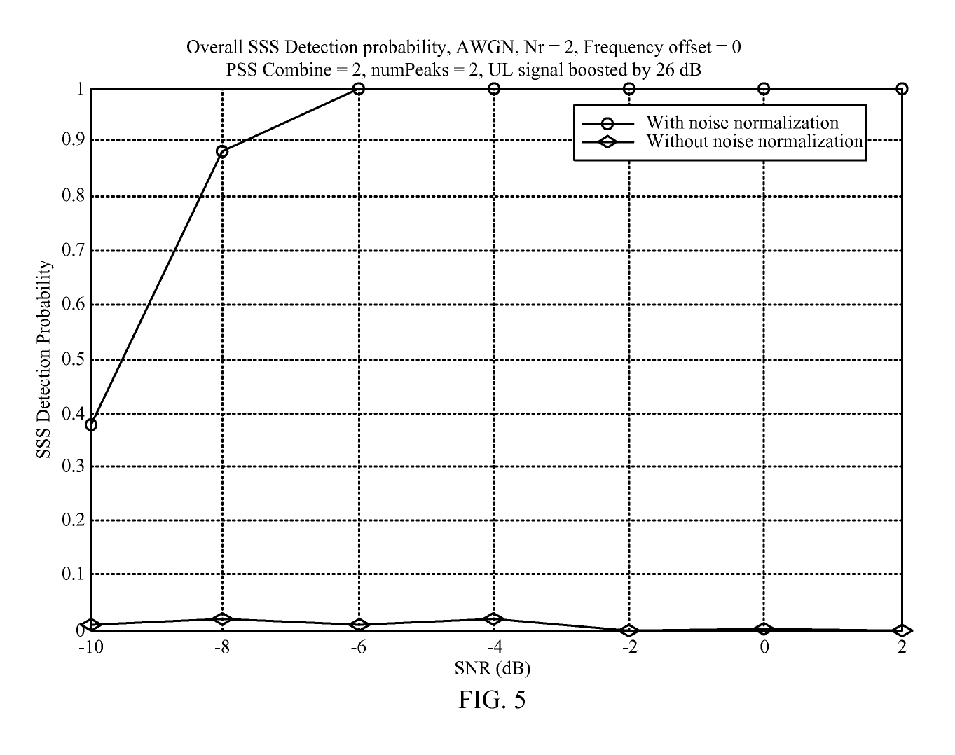

We next evaluate the noise normalization algorithm in a TDD context. We assume that the uplink is boosted relative to the downlink signal and plot the resulting detection probabilities in FIGS. 3, 4 and 5.

The clear message of FIGS. 3, 4, and 5 is that noise normalization during PSS detection is absolutely necessary during initial acquisition during TDD, since high powered uplink transmissions can result in false alarms during initial acquisition. However, the normalizations also serve three other purposes:
1) They weigh the signal across Rx antennas appropriately. Provides resilience against situations where one Rx antenna is experiencing larger noise than the other.
2) Normalizes fading effects over time
3) Allows absolute thresholds to be applied independent of LNA gains applied.

### PSS Collision Interference Cancellation

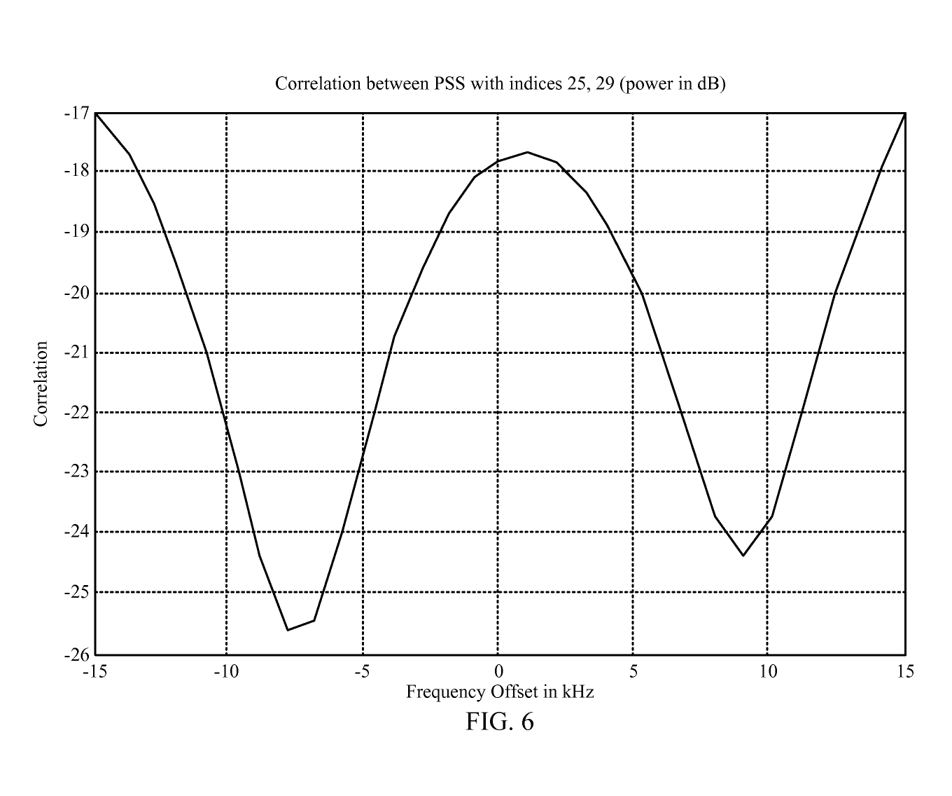

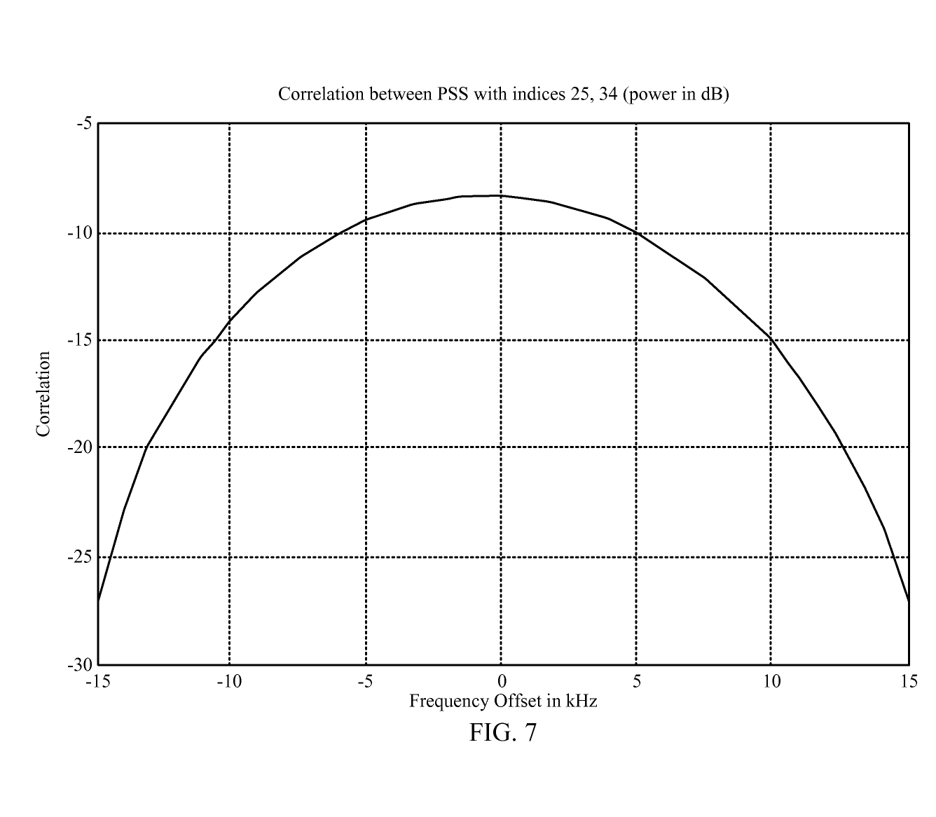

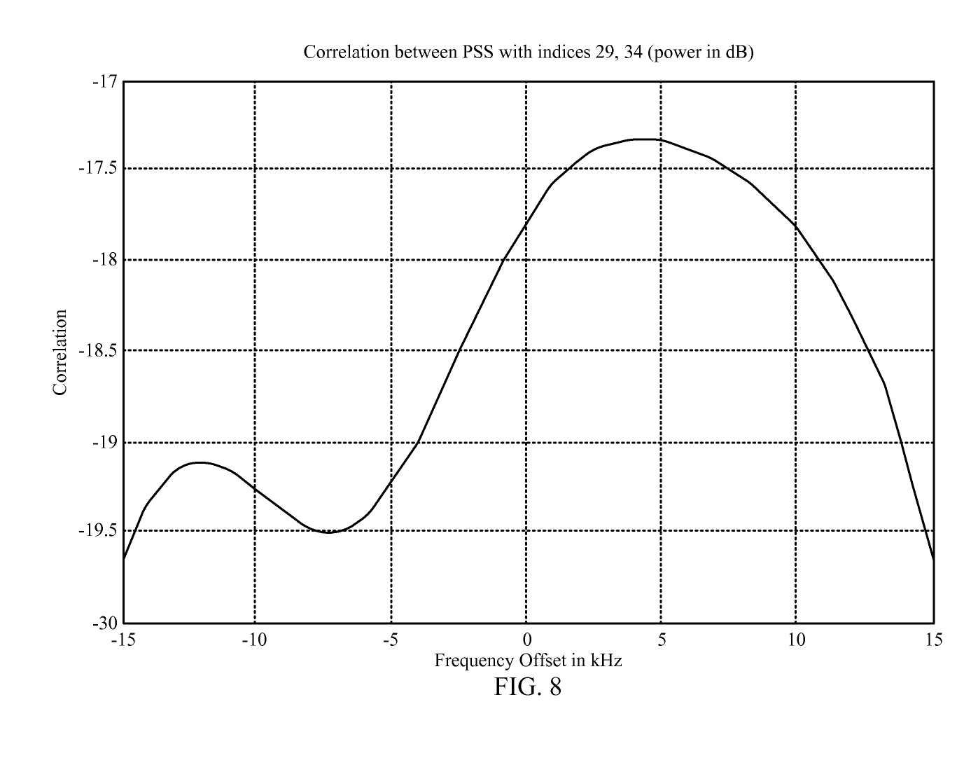

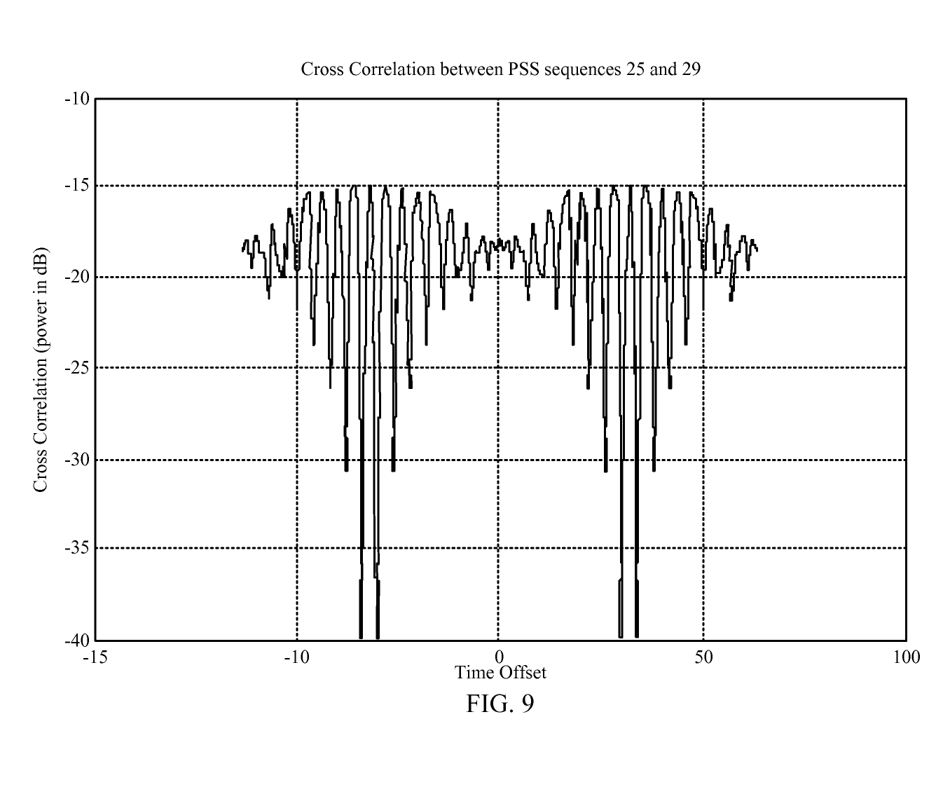

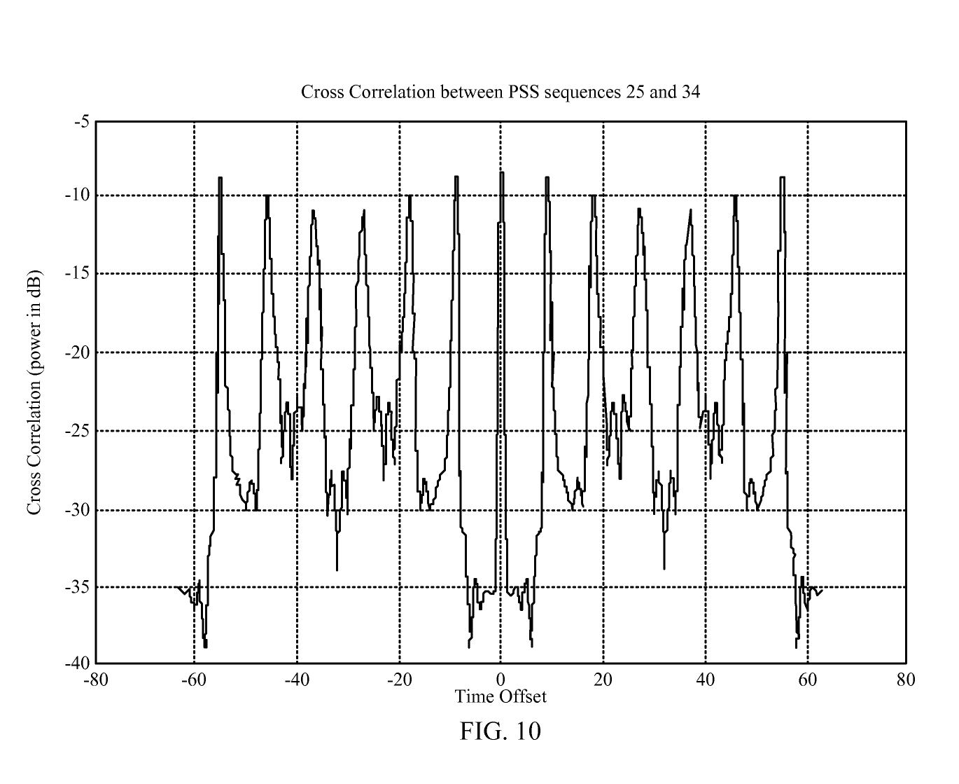

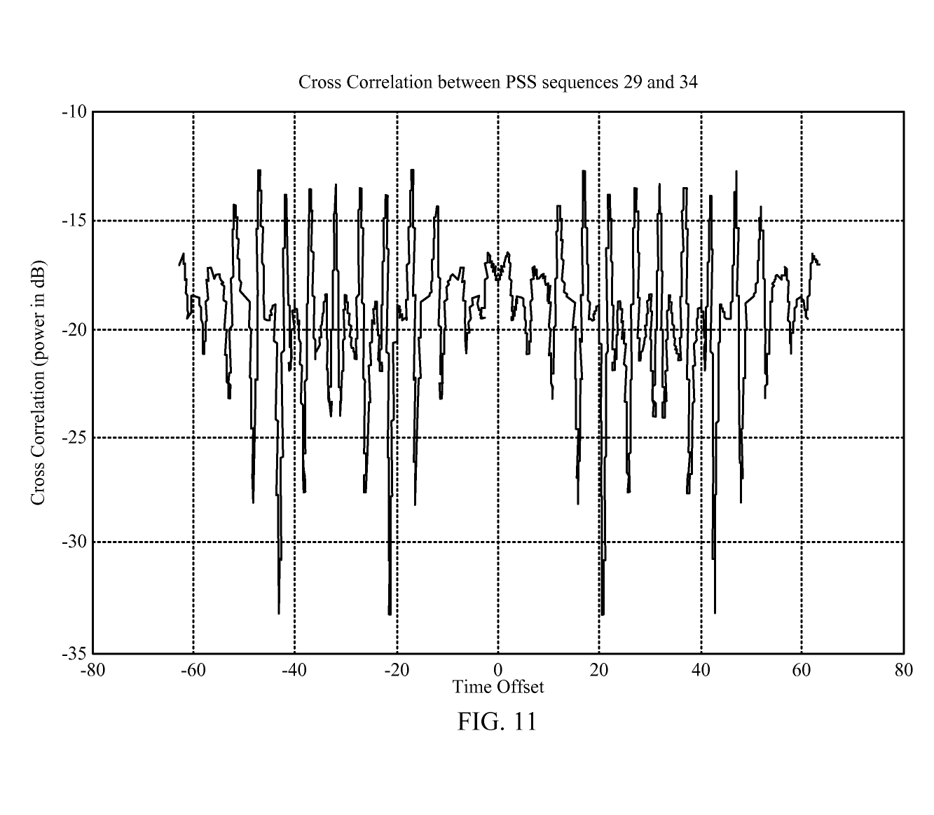

In a synchronous deployment, the probability that PSS transmitted from different base stations collide is non-negligible, i.e., the PSS sequences (including multipath) received from one base station could have coincident timing with PSS sequences from other base stations. The interference from PSS with other indices arising from other base stations is not an issue if the PSS sequences are orthogonal to each other. However, this is not the case, since the PSS sequences with indices 25 and 34 have a non-negligible correlation. To illustrate this point, we plot the correlation of the TD PSS sequences against each other and in the presence of different frequency offsets in FIGS. 6, 7, and 8. In FIGS. 9, 10 and 11 we plot the cross correlation (periodic) between PSS sequences in zero frequency offset and under different time offsets.

PSS transmissions from cells can collide with each other in certain scenarios due to geometry and multipath configuration. In such scenarios where the strongest multipath taps of two base stations are coincident, one base station may hide the signal from the other base station. This situation is not remedied by noncoherent combining of the PSS correlations across 5 ms half-frames. In order to avoid such cases, low-complexity versions of zero-forcing method are proposed to null out colliding PSS sequences of other indices.

Let x₀, x₁ and x₂ denote the TD PSS sequences with indices 25, 29 and 34 respectively that are normalized so that ∥x₀∥=∥x₁∥=∥x₂∥=1. The PSS sequences (normalized to unit energy) exhibit the following cross-correlations.

$${\sum }_{PSS} = [ \begin{matrix}1.0000 & 0.1290 & 0.3844 \\ 0.1290 & 1.0000 & 0.1290 \\ 0.3844 & 0.1290 & 1.0000\end{matrix} ] \qquad ( 1.16 )$$

In terms of power level in dB scale, taking 20log₁₀(.) of the elements in (1.16), we obtain

$${\sum }_{PSS , dB} = [ \begin{matrix}0.0000 & - 17.786 & - 8.3044 \\ - 17.786 & 0.0000 & - 17.786 \\ - 8.3044 & - 17.786 & 0.0000\end{matrix} ] \qquad ( 1.17 )$$

The PSS sequences with indices 29 and 34 are complex conjugates of each other. In HW implementations of PSS/Timing detection, the complex conjugate relation between x₁ and x₂ can be exploited to reduce the number of complex multipliers. We first describe an approach of interference nulling, that does not exploit the above described complex conjugate property. Define the matrices (each ε□^{64×2})

A₀=[x₁ x₂]

A₁=[x₀ x₂]

A₂=[x₀ x₁] (1.18)

Let B₀, B₁ and B₂ be orthogonal projections (each ε□^{64×64}), that span the space orthogonal to the column space of A₀, A₁ and A₂, respectively. Then

Bᵢ=I−Aᵢ(Aᵢ*Aᵢ)⁻¹A*ᵢ, i=0,1,2 (1.19)

This means that B₀x₁=0 and B₀x₂=0 (and likewise for the matrices B₁ and B₂). We define the following ‘effective PSS’ sequences:

\tilde{x}₀=B₀x₀

\tilde{x}₁=B₁x₁

\tilde{x}₂=B₂x₂ (1.20)

The correlation matrix whose (m, n)^{th} entry is 20log₁₀|xₙ*\tilde{x}ₘ| is

$${\sum }_{PSS , ZF , dB} = [ \begin{matrix}- 1.5948 & - 322.9520 & - 320.8889 \\ - 328.1227 & - 0.3519 & - 331.1330 \\ - 319.9936 & - 323.5570 & - 1.5948\end{matrix} ] \qquad ( 1.21 )$$

In practice, the sequences in (1.20) have to be normalized by the absolute values of their correlations with x₀, x₁ and x₂ respectively. In other words, the following normalized effective PSS sequences have to be used:

$${s}_{0} = \frac{{\tilde{x}}_{0}}{‖ {x}_{0}^{*} {\tilde{x}}_{0} ‖} \\ {s}_{1} = \frac{{\tilde{x}}_{1}}{‖ {x}_{1}^{*} {\tilde{x}}_{1} ‖} \\ {s}_{2} = \frac{{\tilde{x}}_{2}}{‖ {x}_{2}^{*} {\tilde{x}}_{2} ‖} \qquad ( 1.22 )$$

Correlating the received sample at all time hypotheses by s₀, s₁ and s₂ have the effect of first nulling out colliding PSS sequences before correlating with the required PSS sequence [see equation (1.21)]. The complexity of the correlations is the same as in the case when correlations with 3 PSS sequences are performed. The only additional computation required is in the beginning in FW (one time), to calculate s₀, s₁ and s₂. These sequences are then read from FW into an internal memory in HW and correlations are performed using them.

### Modified Zero Forcing Algorithms

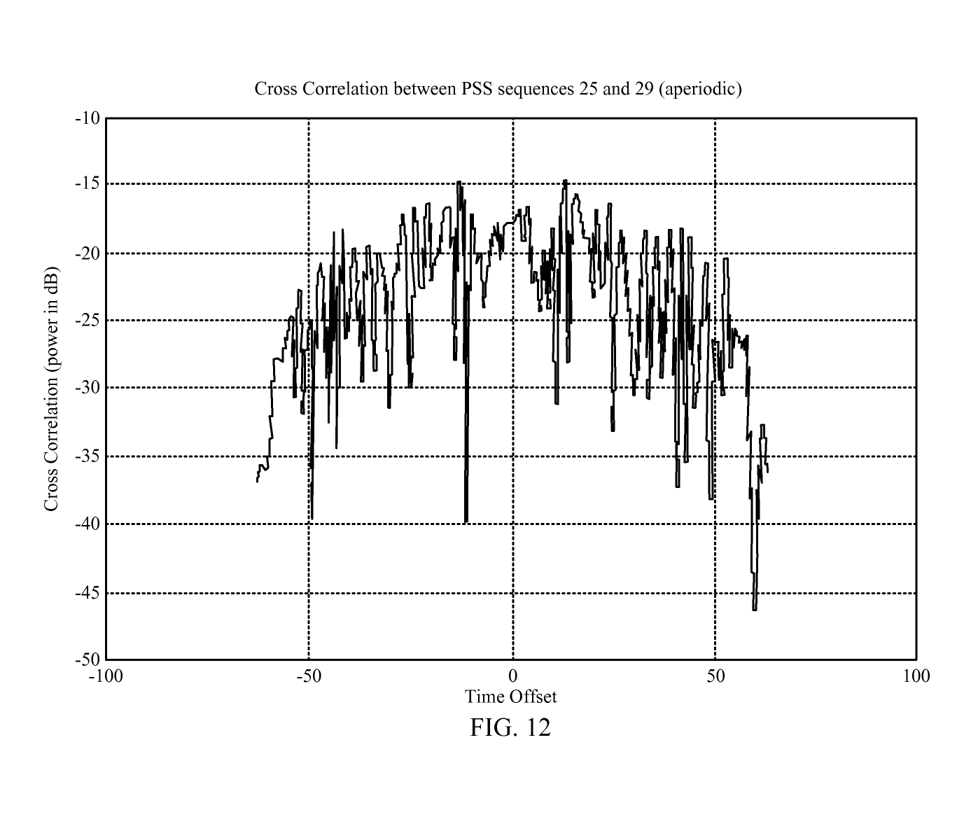

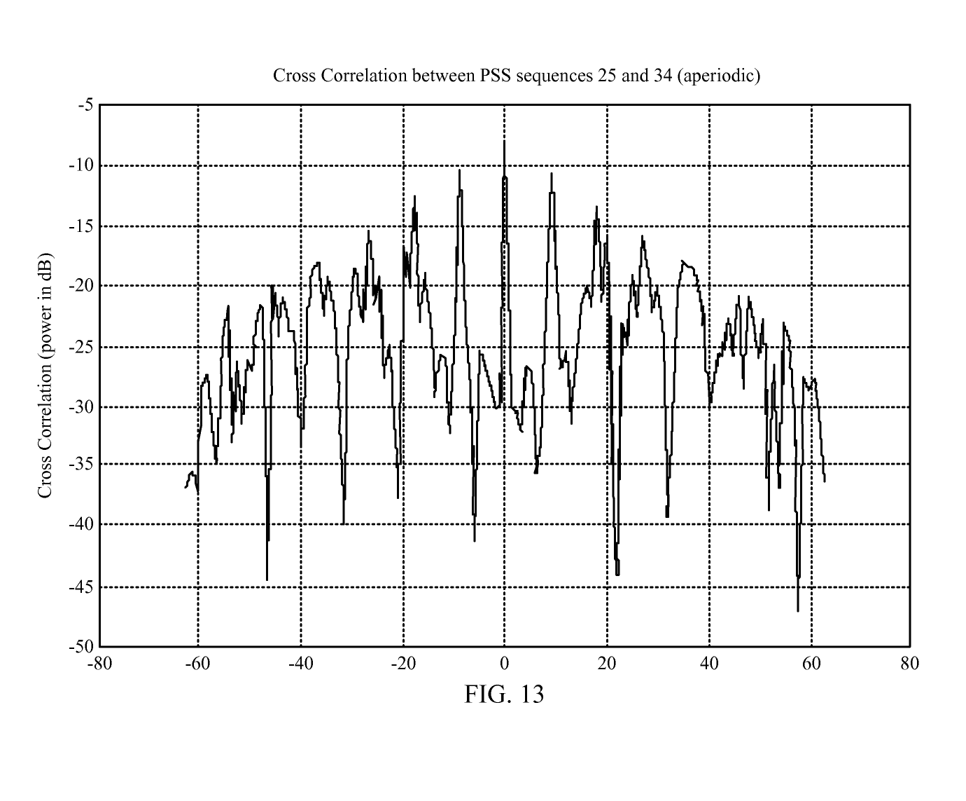

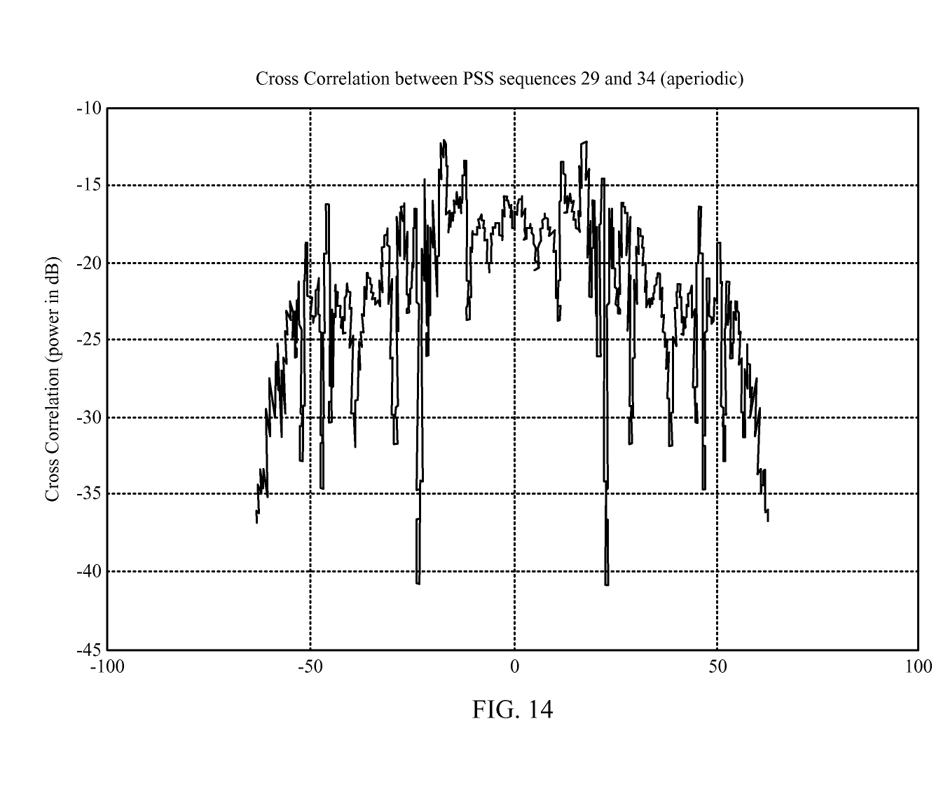

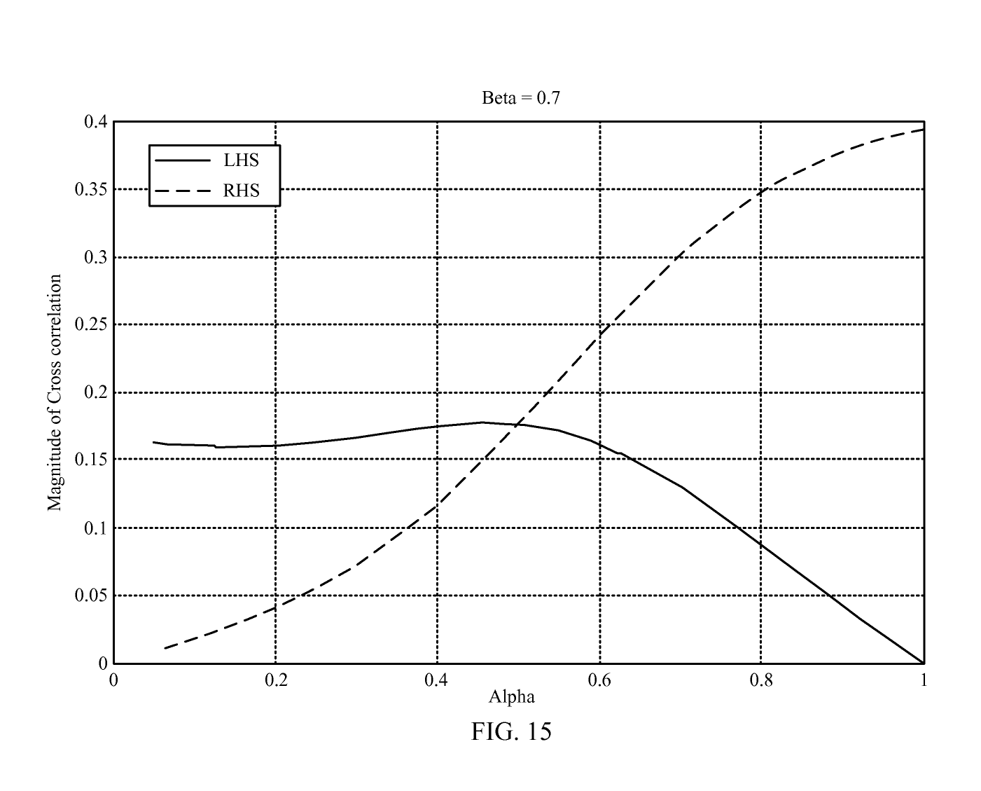

Next, we show that the algorithm can be modified to exploit the complex conjugate property of PSS sequences 29 and 34 in FIGS. 12 through 14 for the cross correlation between PSS sequences 25 and 29 (a periodic); 25 and 34 (a periodic); and 29 and 34 (a periodic) respectively and the magnitude of cross correlation for curves of Left Hand Side (LHS) and Right Hand Side (RHS) in FIG. 15. This modification results in sub-optimality to the zero-forcing algorithm described above but decreases the HW requirement for complex multiplications by one-third, which is significant.

We define effective sequences \hat{x}₀, \hat{x}₁ and \hat{x}₂ such that \hat{x}₁=conj(\hat{x}₂). Clearly, from (1.20), these sequences would be of the form

\hat{x}ᵢ=Cᵢxᵢ, i=0,1,2. (1.23)

In equation (1.23), Cᵢ, i=0,1,2 are projection matrices that null out interfering PSS. Since there is no possibility to reduce the complexity in the correlations corresponding to \hat{x}₀, we set

C₀=B₀ (1.24)

Since x₁=conj(x₂), we want C₁=conj(C₂). Define

[symbol]

₁=[conj(x₀)x₂]

[symbol]

₂=[x₀ x₁] (1.25)

Note that [symbol] ₁=conj( [symbol] ₂) and that instead of using x₀ in the augmented matrix for [symbol] ₁, we have used conj(x₀). Next, define C₁ and C₂ as the orthogonal projections whose column spaces are orthogonal to the column spaces of [symbol] ₁ and [symbol] ₂, ie.,

Cᵢ=I− [symbol] ᵢ( [symbol] ᵢ* [symbol] ᵢ)⁻¹ [symbol] *ᵢ, i=1,2 (1.26)

It can be seen that C₁=conj(C₂). Now, define

\hat{x}ᵢ=Cᵢxᵢ, i=0,1,2. (1.27)

Therefore, \hat{x}ᵢ=conj(\hat{x}₂) and we can use the sequences \hat{x}₀, \hat{x}₁ and \hat{x}₂ as effective PSS sequences without any change in the current HW architecture.

The key to the modified zero forcing procedure is that the correlation between x₀ and x₂ is significantly higher than that between x₀ and x₁. So we make sure that components in the direction of x₀ are nulled out before detecting x₂, but do not null out x₀ components before detection x₁. Instead, to ensure that the final effective PSS sequences \hat{x}₁ and \hat{x}₂ are complex conjugates, we null out conj(x₀) before detecting x₁. There is a penalty for substituting conj(x₀) instead of x₀ in the zero forcing matrix for x₁, since the correlation coefficient between conj(x₀) and x₁ is 0.3844, while the correlation coefficient between x₀ and x₁ is 0.1290 (which is the cancellation that is needed). To understand the loss, the following is the correlation matrix whose (m,n)^{th} entry is 20log₁₀|xₙ*\hat{x}ₘ| is

$${\sum }_{PSS , ModifiedZF 1 , dB} = [ \begin{matrix}- 1.5948 & - 322.9520 & - 320.8889 \\ - 15.5981 & - 1.5948 & - 323.8009 \\ - 319.9936 & - 323.5570 & - 1.5948\end{matrix} ] \qquad ( 1.28 )$$

It should be noted that the zero forcing (ZF) and modified ZF methods achieved complete nulling in certain PSS pairs. This complete nulling is not required in practice, and the level of interference nulling can be traded off for increased signal energy. In other words, the AWGN performance can be boosted in exchange for partial nulling. Moreover, instead of nulling conj(x₀) in [symbol] ₁, we can instead optimize in a minimax manner over a broader class of complex conjugate partial interference nulling matrices as follows. Consider the following matrices

F₀=[x₁ x₂]

F₁=[αx₀+(1−α) x̅₀ x₂]

F₂=[α x̅₀+(1−α)x₀ x₁] (1.29)

Let 0<β≦1 and define the following orthogonal projection matrices

Eᵢ=I−βFᵢ(Fᵢ*Fᵢ)⁻¹F*ᵢ, i=0,1,2 (1.30)

Then the effective PSS sequences are

zᵢ=Eᵢxᵢ, i=0,1,2 (1.31)

Note that z₁= z̅₂ as needed. Moreover, for any 0<β≦1, the value of α that minimizes the maximum correlation between (x₀, z₁) and (x₀, z₂) (minimax problem) is obtained by solving

|x₀*E₁x₁|=|x₀*E₂x₂| (1.32)

When β=1, we get the standard zero forcing matrices that perform complete nulling (−∞dB). When β=0, no interference cancellation is performed. Here, we choose β<1 so that the interference cancellation is partial, and the effective signal energy is higher. As an example, consider β=1. Then the plots of the LHS and RHS of equation (1.32) is provided in Clearly, α=0.5 minimizes the maximum correlation between effective sequences z₁ and z₂ and the PSS sequence x₀. For α=0.5 and β=0.7, the correlation matrix whose (m, n)^{th} entry is 20log₁₀|xₙ*zₘ| is

$${\sum }_{PSS , ModifiedZF 2 , dB} = [ \begin{matrix}- 1.0849 & - 28.2436 & - 18.7619 \\ - 18.6122 & - 0.8006 & - 28.2436 \\ - 12.7082 & - 28.2436 & - 0.8006\end{matrix} ] \qquad ( 1.33 )$$

Based on simulations and from (1.33), effective PSS sequences in (1.31) that use this choice of α and β appear to considerably null colliding PSS signals as well as conserve signal energy. These sequences are normalized similar to (1.22) in firmware (FW) and read into hardware (HW) before correlations.

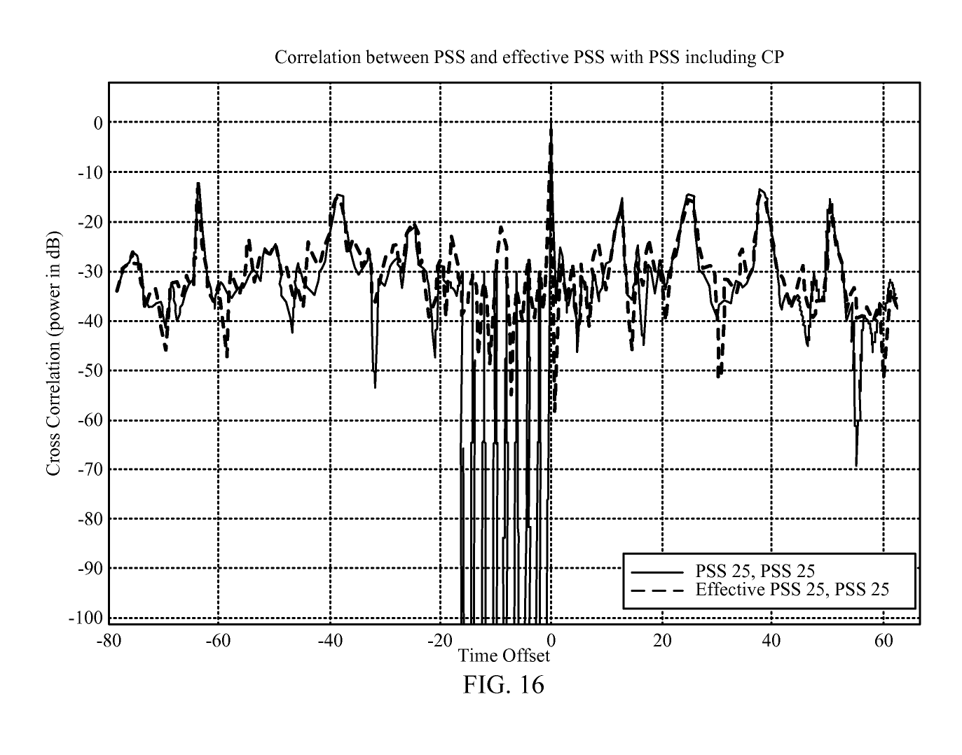

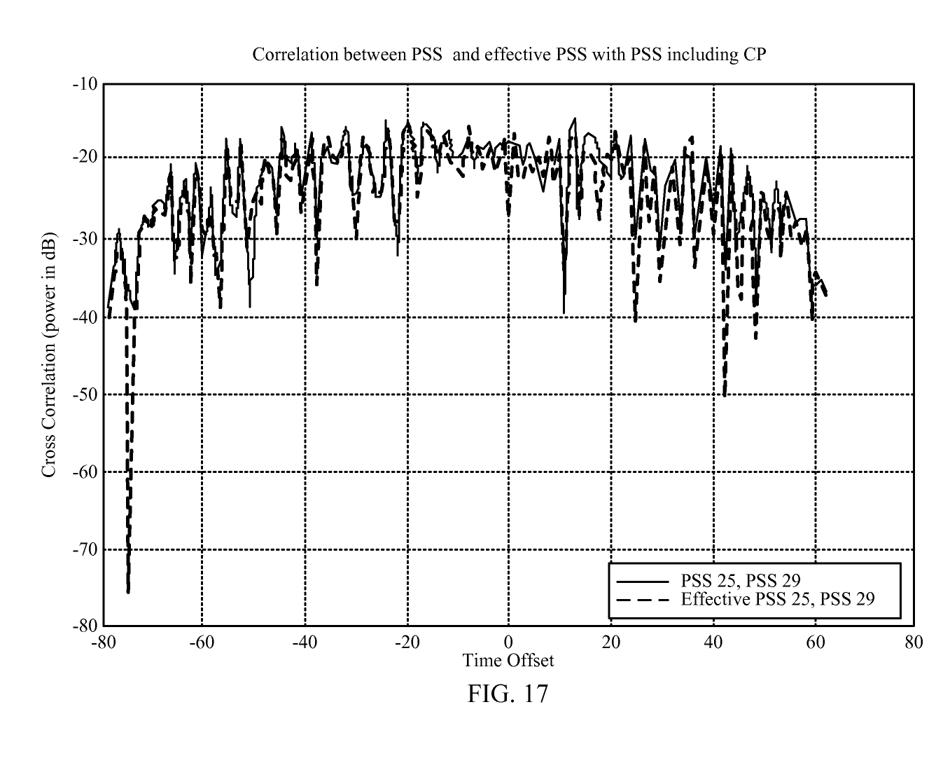

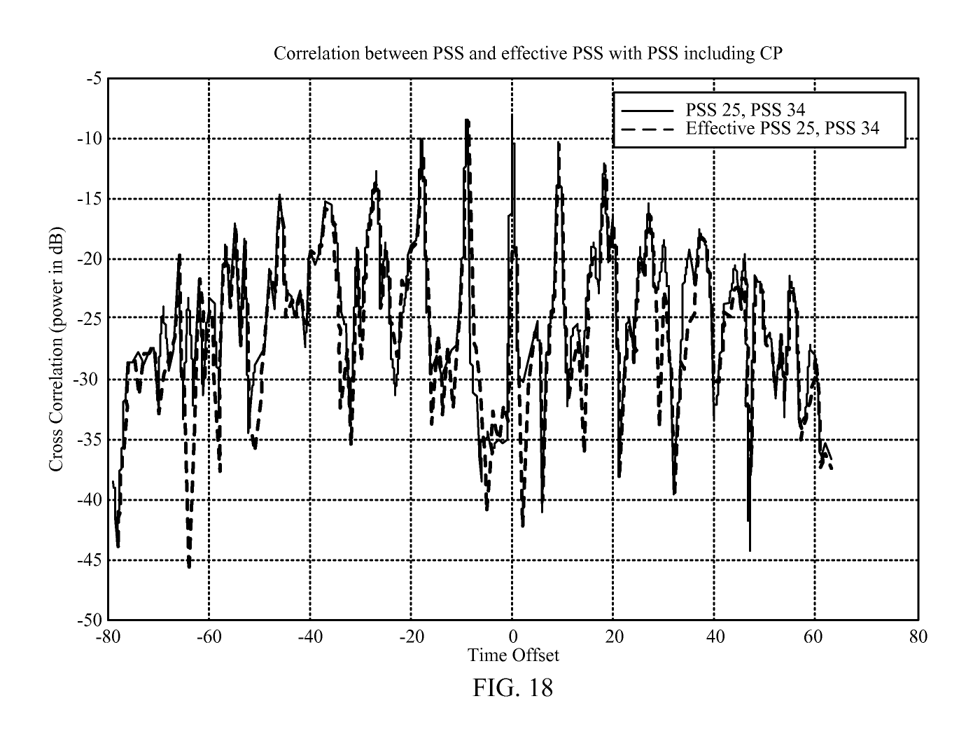

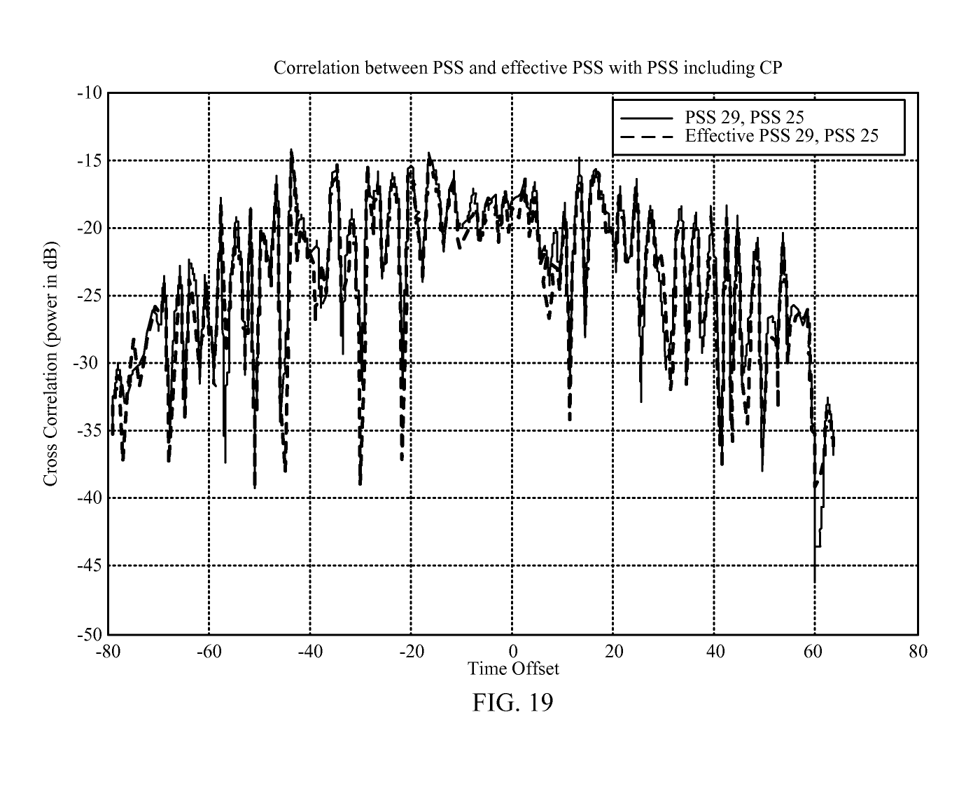

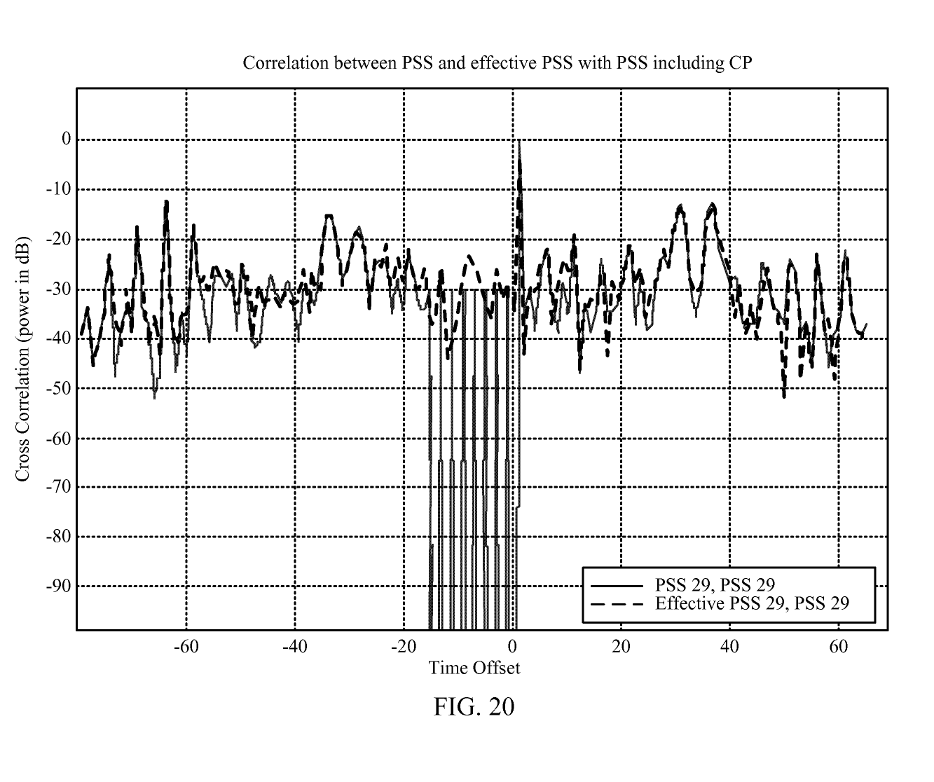

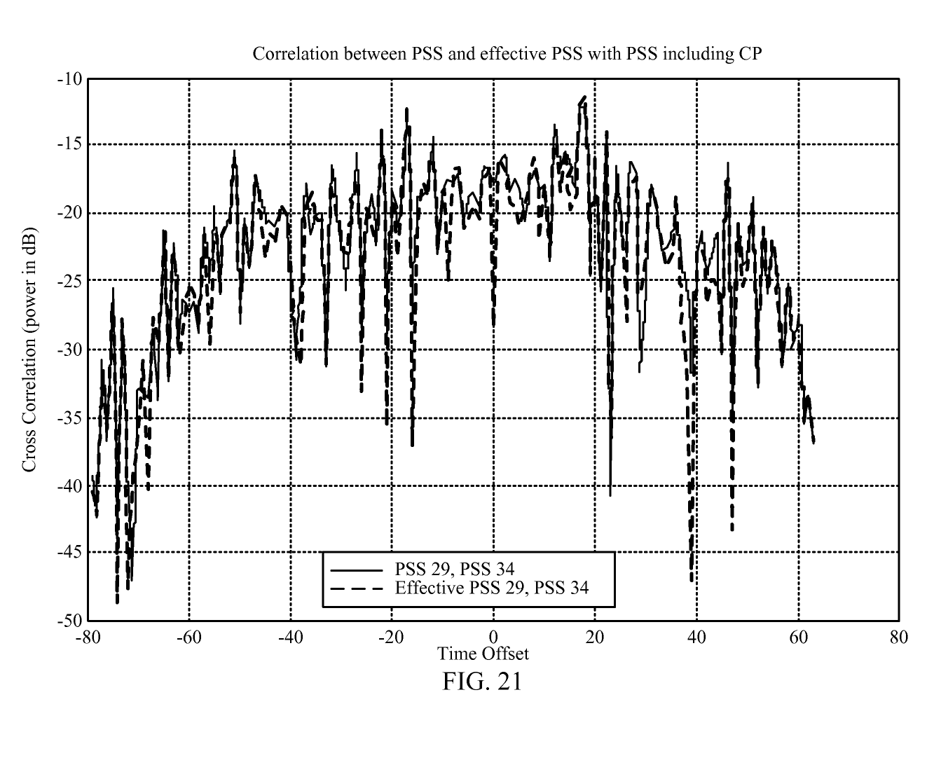

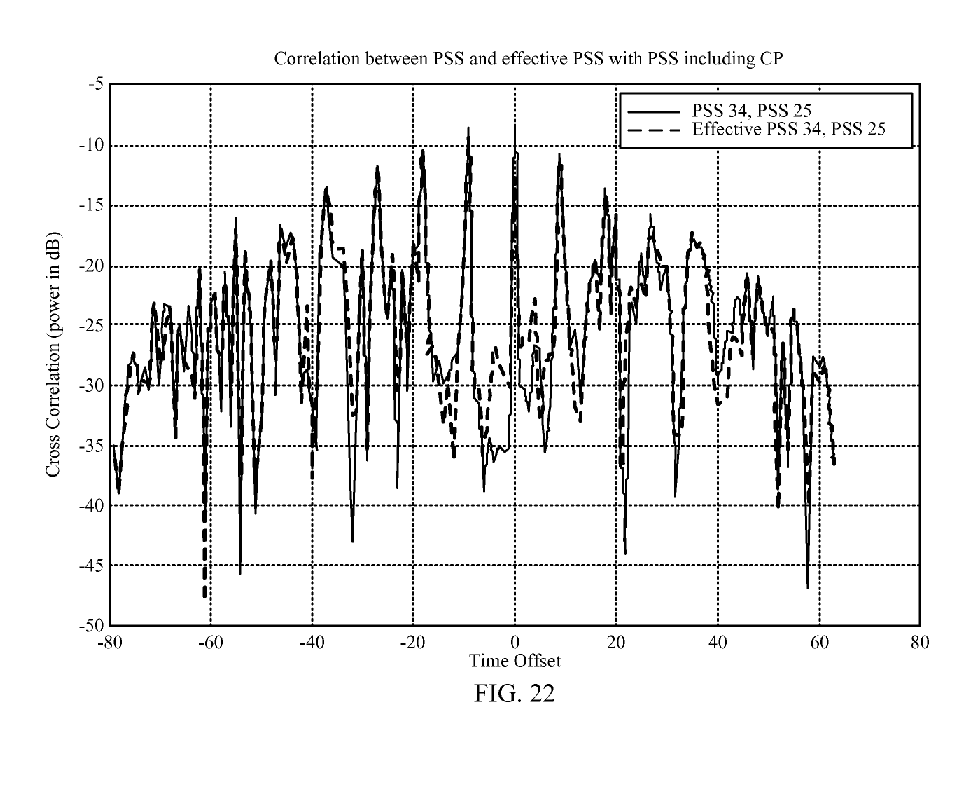

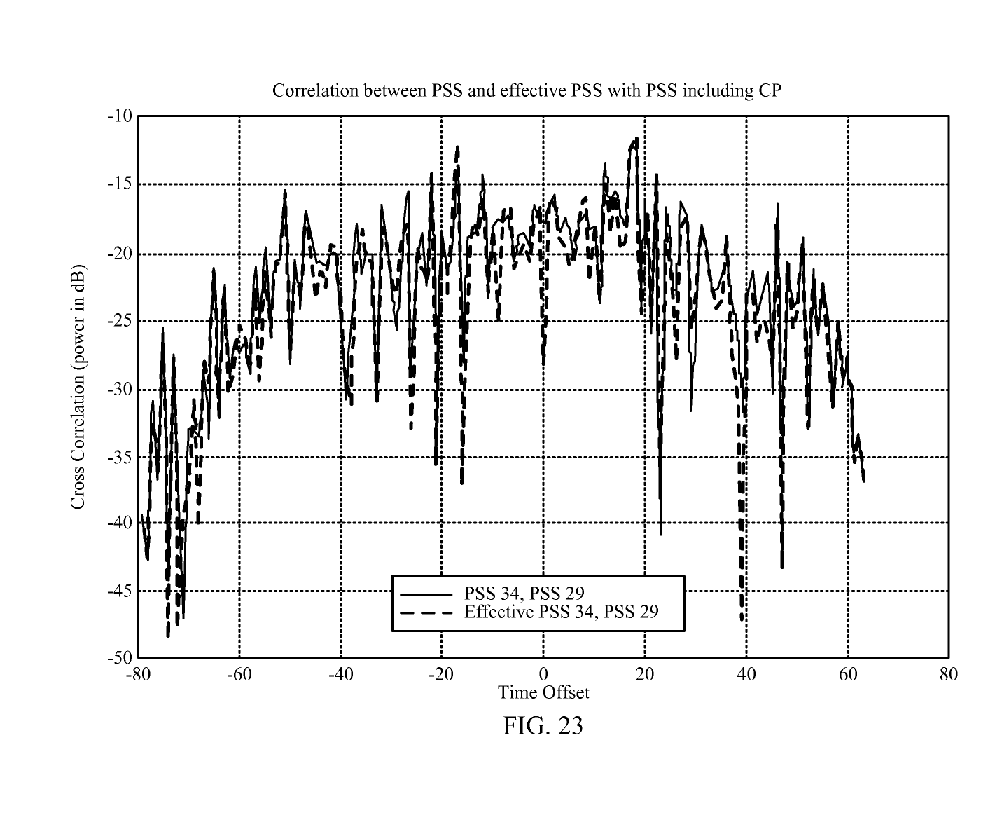

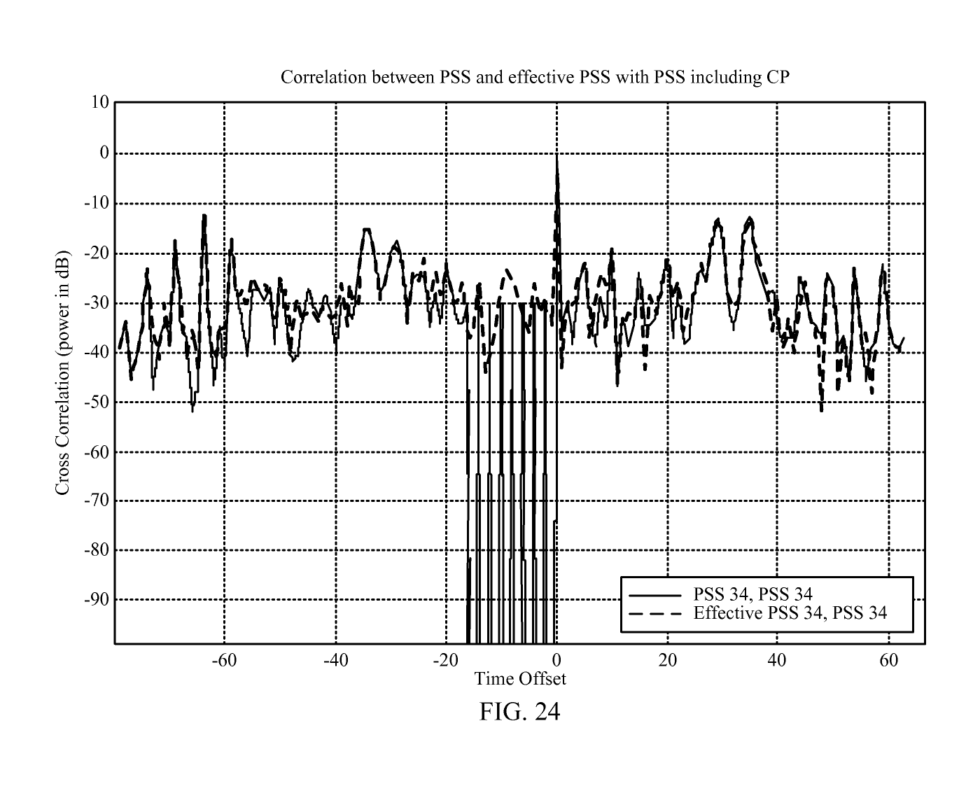

To observe the impact of the effective PSS sequences on the timing detection correlations, we next plot correlations for different time offsets from FIGS. 16 to 24. We essentially correlate the effective PSS sequences zᵢ, i=0,1,2 with PSS sequences xᵢ, i=0,1,2 that include the extended CP of length 16 (at 0.96 MHz) and plot the power levels in dB. For better resolution, we truncate the plots at −100 dB.

Notice that from FIGS. 16 to 24, the effective PSS sequence correlations are similar to the PSS correlations, except that there is significant attenuation at the needed zero time offsets (e.g. between PSS 25 and PSS 34 at time offset 0). If necessary, more sequences can be included in the zero forcing algorithms.

### SSS Detection

Next, we discuss noise normalization applied during SSS detection. The mathematical notations used in this section are independent from the previous sections (to allow reuse of parameter names).

SSS detection is performed in the frequency domain (FD). After taking an FFT of the low pass filtered SSS received samples, the resulting FD signal for Rx antenna i can be modeled as

yᵢ=e^{j2π(f}^{ₒ}⁻ [symbol] ^{)T}^{ₛ}^{(N+CP)} [symbol] ᵢx+nᵢ, i=1,2 (1.34)

In equation (1.34), for Rx antenna i, yᵢ ε□^{64×1} is the received SSS sequence in FD, x ε□^{64×1} is the FD SSS signal, [symbol] ᵢ ε [symbol] is diagonal matrix which contains the estimated FD channel response coefficients that are assumed uncorrupted by additive noise but are corrupted by a noisy local oscillator frequency offset estimate and nᵢ is the FD additive white Gaussian noise. We assume that the noise is distributed as nᵢ˜Cη(0, [symbol] ᵢ²I), i=1,2, where [symbol] ᵢ² is a perfect estimate of the noise variance. Also, fₒ is the frequency offset and [symbol] is its estimate. This frequency error accumulates over an OFDM symbol length+CP length and results in a phase error during SSS detection. Since this phase error is observed to be large during initial acquisition, since it is impossible to render the frequency offset estimation error negligible with just the PSS/SSS, it reasonable to assume that the phase error is unknown and distributed uniformly within [0, 2π].

An important observation is that the phase error across Rx antennas is the same for both antennas, since the frequency error is the same. The optimal detector (in an ML sense) under the assumptions would be found to be as follows

$$\hat{x} = arg {max}_{x} \vert \frac{x * {Λ}_{1} * {y}_{1}}{{{σ}^{•}}_{1}^{2}} + \frac{x * {Λ}_{2} * {y}_{2}}{{{σ}^{•}}_{2}^{2}} \vert \qquad ( 1.35 )$$

It should be noted that the correlations of the matched filtered received sequence with the SSS sequence are first coherently combined and the magnitude of the resulting value is used as the detection metric. In rule (1.35), note that we used the estimated noise variance [symbol] ᵢ² instead of the actual noise variance. These noise variances are estimated in FW using the following FD pattern (based on FD SSS and FD channel estimate)

\tilde{x}= [symbol] x (1.36)

We calculate the noise variance exactly as described in Section 2.1, except that we use \tilde{x} instead of x. A point to note is that the noise estimation is done in FD rather than TD. In FD noise estimation, all multipath are used at once to estimate the noise, while in TD noise estimation a single path is used to estimate the noise. This results in a more reliable estimate of noise variance. An implementation related detail is that the detection rule in (1.35) would be sub-optimal if the LNA gain applied on the PSS is different from that applied on the SSS.

### Searcher Issues in TDD

There are a few issues in the searcher that are tied to the standard specification. Since the standard is unlikely to change in the near future, resolving some of these issues are fundamentally limited and improving the performance requires careful network planning

The PSS and SSS in FDD mode are adjacent OFDM symbols. Once the PSS and timing are detected, it is convenient to use the PSS as a reference, and decode the SSS coherently. This is possible since the PSS and SSS are close in TD and the channel variation across an OFDM symbol is not large even at high Doppler. In TDD however, the PSS and SSS are two OFDM symbols apart. This makes coherent detection of SSS more vulnerable to large Doppler scenarios, where the channel could decorrelate within 2 OFDM symbols.

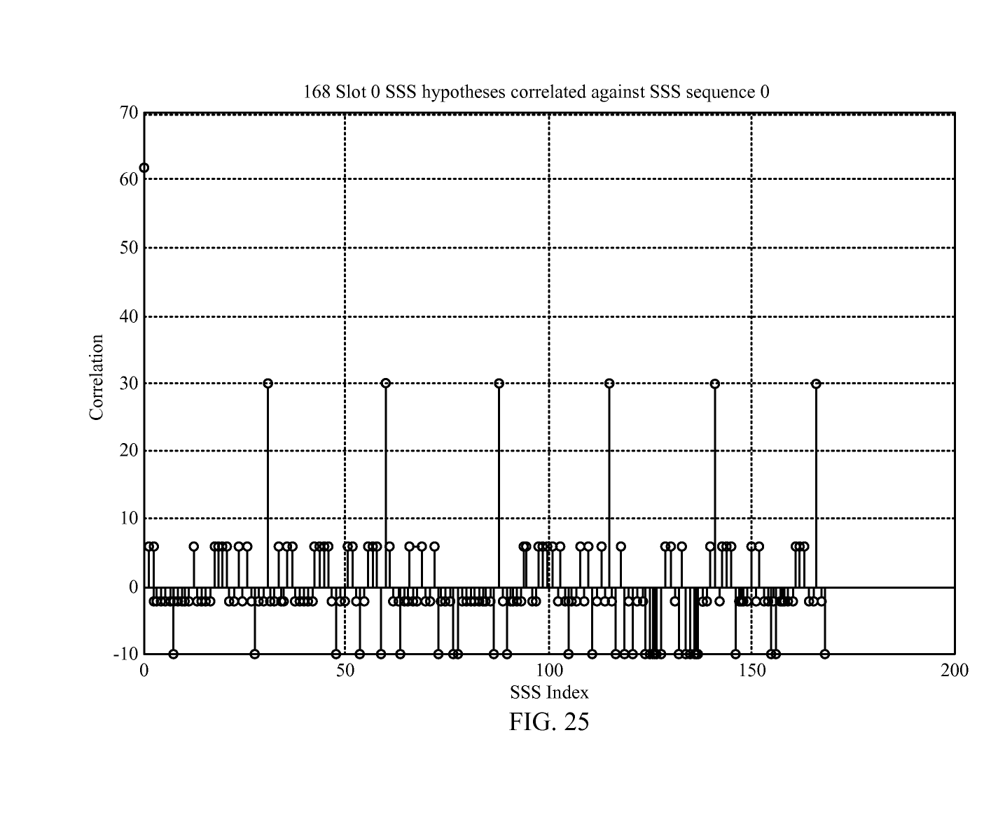

The other issue is the lack of separation between certain SSS sequences. It turns out that due to the scrambling method adopted, certain SSS sequences that correspond to the same PSS index have a cross correlation that is quite large (=0.5 or −3 dB). This is illustrated in FIG. 25.

This is fundamentally due to the small lengths of the SSS and the choice of the SSS and scrambling sequences. While this issue is present even for FDD, the asynchronous nature of transmissions reduces the probability of a collision. In a synchronous deployment however, the probability of collision is non-negligible.

### Implementation Changes

Since the PSS and SSS sequences are defined the same way in FDD and TDD and the detection algorithms are essentially the same, the task structures in FW would remain essentially the same for both modes. One key difference is that the PSS and SSS are spaced 2 symbols apart in TDD. So while pushing samples from the sample server to FW for SSS detection, this fact has to be taken into account.

The noise normalizations have to be factored into both PSS and SSS detection algorithms. The noise normalization algorithm for PSS detection is absolutely essential for TDD search to work. Noise normalizations for PSS and SSS detection are helpful even for FDD mode since Rx antenna noise statistics may be biased and it is convenient to normalize so that LNA gains do not need to be factored into thresholds. This results in harmony between TDD and FDD algorithms.

The zero forcing algorithms require no change to HW. This is because these sequences have to be generated just once in FW and read into an internal memory in HW before being used as with the original sequences. The construction of two modified ZF sequences that are complex conjugates mimics the original PSS sequences, allowing the same efficient implementation in HW without changes.

The most important difference is that in TDD, LNA gain changes are applied one at a time during the entire PSS/SSS detection procedure per carrier frequency. Specifically, LNA gain changes are applied only if a PSS/SSS search is unsuccessful. This is different from FDD where LNA gain changes may occur in the middle of search. For more details on LNA gain changes in TDD search.

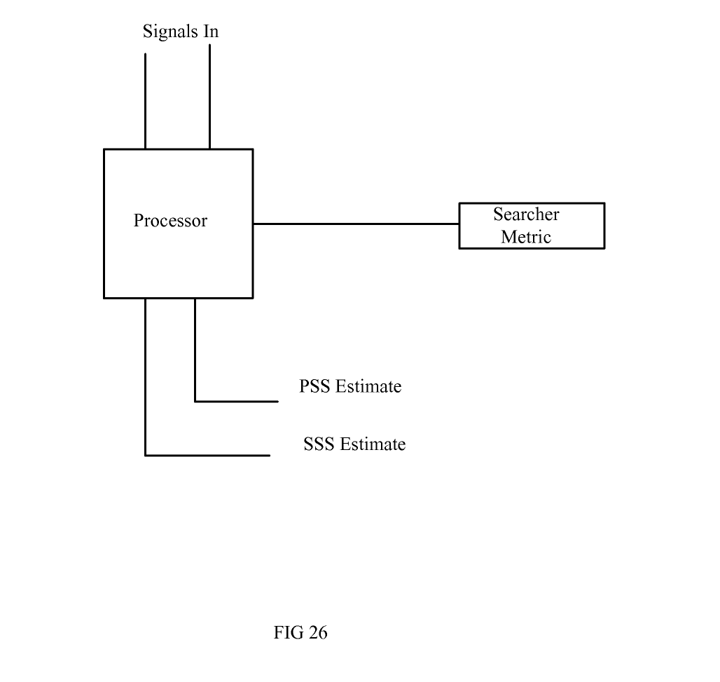

A new searcher metric is advanced herein as EM divided by NM that effectively cancels out the power variations and restores the accuracy of the hypothesis test. This can be seen with clarity by reference to the performance plot of FIG. 2, which is a graph showing SSS detection probability verses SNR (dB), which shows the lower red curve without noise normalization and the upper blue curve with noise normalization. More particularly, the lower red curve shows how probability detection become 0 with legacy searcher implementations in a TDD system, and the upper blue curve depicts how the present innovation restores the performance to its full level. FIG. 26 illustrates a use of the searcher metric as implemented by a processor. The synchronizations are shown as being input as processed in relation to the searcher metric to properly identify the synchronization signals.

The word “exemplary” is used herein to mean “serving as an example, instance, or illustration.” Any embodiment described herein as “exemplary” is not necessarily to be construed as preferred or advantageous over other embodiments.

A HDR subscriber station, referred to herein as an access terminal (AT), may be mobile or stationary, and may communicate with one or more base stations, referred to as modem pool transceivers (MPTs). An access terminal transmits and receives data packets through one or more modem pool transceivers to an HDR base station controller, referred to herein as a modem pool controller (MPC). Modem pool transceivers and modem pool controller are parts of a network called an access network. An access network transports data packets between multiple access terminals. The access network may be further connected to additional networks outside the access network, such as a corporate intranet or the Internet, and may transport data packets between each access terminal and such outside networks. An access terminal that has established an active traffic connection with one or more modem pool transceivers is called an active access terminal, and is said to be in a traffic state, and is said to be in a traffic state. An access terminal that is in the process of establishing an active traffic channel connection with one or more modem pool transceivers is said to be in a connection setup state. An access terminal may be an data device that communicates through a wireless channel or through a wired channel, for example using fiber optic or coaxial cables. An access terminal may further be any of a number of types of devices including but not limited to PC card, compact flash, external or internal modem, or wireless or wire line phone. The communication link through which the access terminal sends signals to the modem pool transceiver is called a reverse link. The communication link through which a modem pool transceiver sends signals to an access terminal is called a forward link.

We claim:

1. In a wireless communication system employing frequency division duplexing (FDD) that may be synchronous or asynchronous for transmitting data, in which the underlying Rx signals have different statistics, and where the hypothesis testing is degraded thereby, the improvement of generating a complementary searcher metric that is a noise metric (NM) comprising:
projecting the Rx signals into the noise subspace of a pilot sequence.

2. The method of claim 1, wherein the noise metric (NM) is generated from the same set of Rx signal samples used to generate energy metrics (EM) to thereby share the same statistics.

3. The method of claim 2, wherein the same statistics are gain scaling arising out of power variations in the Rx samples.

4. The method of claim 1, wherein said complementary searcher metrics is the EM divided by the noise metric (NM) to effectively cancel out power variations and restore the accuracy of said hypothesis testing.

5. The method of claim 1, wherein changes are made to said frequency division duplexing to enable said method to apply to a time division duplexing (TDD) mode that is synchronous, comprising normalizing the searcher metric using a timing detection algorithm to account for large power differences between the uplink (UL) and downlink (DL) transmissions.

6. The method of claim 5, wherein a primary synchronization signal (PSS) is detected according to a timing hypothesis when received samples are correlated against a reference sequence, x, in order to determine a correlation peak indicative of a symbol boundary of the PSS, with normalization, according to the maximum, providing a detection rule, as follows:
$${arg {max}_{x}}_{Over multiple time hypotheses of data y} \frac{\vert x * {y}_{1} \vert}{\frac{1}{N - 1} ( {y}_{1} * {y}_{1} - {\vert x * {y}_{1} \vert}^{2} )} + \frac{{\vert x * {y}_{2} \vert}^{2}}{\frac{1}{N - 1} ( {y}_{2} * {y}_{2} - {\vert x * {y}_{2} \vert}^{2} )} .$$

7. The method of claim 5, wherein a primary synchronization signal (PSS) is detected according to a timing hypothesis when received samples are correlated against a reference sequence, x, in order to determine a correlation peak indicative of a symbol boundary of the PSS, with normalization, according to the maximum, providing a detection rule as follows:
$${arg {max}_{x}}_{Over PSS indices and multiple time hypotheses of data y} \frac{{\vert x * {y}_{1} \vert}^{2}}{{\vert \vert {y}_{1} \vert \vert}^{2} ( {y}_{1} * {y}_{1} - {\vert x * {y}_{1} \vert}^{2} )} + \frac{{\vert x * {y}_{2} \vert}^{2}}{{\vert \vert {y}_{2} \vert \vert}^{2} ( {y}_{2} * {y}_{2} - {\vert x * {y}_{2} \vert}^{2} )}$$

8. The method of claim 5, wherein a primary synchronization signal (PSS) is detected according to a timing hypothesis when received samples are correlated against a reference sequence, x, in order to determine a correlation peak indicative of a symbol boundary of the PSS, with normalization, according to the maximum, providing a detection rule as follows:
$${arg {max}_{x}}_{Over multiple time hypotheses of data y} \frac{{\vert x * {y}_{1} \vert}^{2}}{{\vert \vert {y}_{1} \vert \vert}^{2}} + \frac{{\vert x * {y}_{2} \vert}^{2}}{{\vert \vert {y}_{2} \vert \vert}^{2}}$$

9. The method of claim 5, wherein a primary synchronization signal (PSS) is detected according to a timing hypothesis when received samples are correlated against a reference sequence, x, in order to determine a correlation peak indicative of a symbol boundary of the PSS, with normalization, according to the maximum, providing a detection rule as follows:
$${arg {max}_{x}}_{Over multiple time hypotheses of data y} \frac{{\vert x * {y}_{1} \vert}^{2}}{{E}_{1}} + \frac{{\vert x * {y}_{2} \vert}^{2}}{{E}_{2}}$$

10. A detector apparatus comprising means to detect a primary synchronization signal (PSS) according to a timing hypothesis wherein received wherein received samples are correlated against a reference sequence, x, in order to determine a correlation peak indicative of a symbol boundary of the PSS, with normalization, using an argument of the maximum, providing a detection rule determined according to the following:
$${arg {max}_{x}}_{Over PSS indices and multiple time hypotheses of data y} \frac{{\vert x * {y}_{1} \vert}^{2}}{\frac{1}{N - 1} ( {y}_{1} * {y}_{1} - {\vert x * {y}_{1} \vert}^{2} )} + \frac{{\vert x * {y}_{2} \vert}^{2}}{\frac{1}{N - 1} ( {y}_{2} * {y}_{2} - {\vert x * {y}_{2} \vert}^{2} )}$$

11. A detector apparatus comprising means to detect a primary synchronization signal (PSS) according to a timing hypothesis wherein received samples are correlated against a reference sequence, x, to determine a correlation peak inductive of a symbol boundary of the PSS, with normalization, using an argument of the maximum, providing a detection rule determined according to the following:
$${arg {max}_{x}}_{Over PSS indices and multiple time hypotheses of data y} \frac{{\vert x * {y}_{1} \vert}^{2}}{{\vert \vert {y}_{1} \vert \vert}^{2} ( {y}_{1} * {y}_{1} - {\vert x * {y}_{1} \vert}^{2}} + \frac{{\vert x * {y}_{2} \vert}^{2}}{{\vert \vert {y}_{2} \vert \vert}^{2} ( {y}_{2} * {y}_{2} - {\vert x * {y}_{2} \vert}^{2} )}$$

12. A detector apparatus comprising means to detect a primary synchronization signal (PSS) according to a timing hypothesis wherein received samples are correlated against a reference sequence, x, to determine a correlation peak inductive of a symbol boundary of the PSS, with nomination, using an argument of the maximum, providing a detection rule determined according to the following:
$${arg {max}_{x}}_{Over PSS indices and multiple time hypotheses of data y} \frac{{\vert x * {y}_{1} \vert}^{2}}{{\vert \vert {y}_{1} \vert \vert}^{2}} + \frac{{\vert x * {y}_{2} \vert}^{2}}{{\vert \vert {y}_{2} \vert \vert}^{2}}$$

13. A detector apparatus comprising means to detect a primary synchronization signal (PSS) according to a timing hypothesis wherein received samples are correlated against a reference sequence, x, to determine a correlation peak inductive of a symbol boundary of the PSS, with nomination, using an argument of the maximum, providing a detection rule determined according to the following:
$${arg {max}_{x}}_{Over PSS indices and multiple time hypotheses of data y} \frac{{\vert x * {y}_{1} \vert}^{2}}{{E}_{1}} + \frac{{\vert x * {y}_{2} \vert}^{2}}{{E}_{2}}$$

14. In an apparatus in a wireless communication system employing frequency division duplexing (FDD) that may be synchronous or asynchronous for transmitting data, in which the underlying Rx signals have different statistics, and where the hypothesis testing is degraded thereby, the improvement comprising:
means for generating a complementary searcher metric that is a noise metric (NM); and
means for projecting the Rx signals into the noise subspace of a pilot sequence.

15. The apparatus of claim 14, wherein the noise metric (NM) is generated from the same set of Rx signal samples used, and further comprising means to generate energy metrics (EM) to thereby share the same statistics.

16. The apparatus of claim 15, comprising the same statistics, and further comprising means to provide the same gain scaling arising out of power variations in the Rx samples.

17. The apparatus of claim 14, comprising means to provide said complementary searcher metrics that is the EM divided by the noise metric (NM) to effectively cancel out power variations and restore the accuracy of said hypothesis testing.

18. The apparatus of claim 15, comprising means to change said frequency division duplexing to a time division duplexing (TDD) mode that is synchronous, and means for normalizing the searcher metric using a timing detection algorithm to account for large power differences between the uplink (UL) and downlink (DL) transmissions.

19. The apparatus of claim 18, comprising means to detect a primary synchronization signal (PSS) detected according to a timing hypothesis received samples are correlated against a reference sequence, X, to determine a correlation peak indicative of a symbol boundary of the PSS, with normalization, according to the maximum, providing a detection rule, as follows:
$${arg {max}_{x}}_{Over multiple time hypotheses of data y} \frac{{\vert x * {y}_{1} \vert}^{2}}{\frac{1}{N - 1} ( {y}_{1} * {y}_{1} - {\vert x * {y}_{1} \vert}^{2} )} + \frac{{\vert x * {y}_{2} \vert}^{2}}{\frac{1}{N - 1} ( {y}_{2} * {y}_{2} - {\vert x * {y}_{2} \vert}^{2} )}$$

20. The apparatus of claim 18, comprising means to detect a primary synchronization signal (PSS) according to a timing hypothesis when received samples are correlated against a reference sequence, x, to determine a correlation peak indicative of a symbol boundary of the PSS, with normalization, according to the maximum, providing a detection rule, as follows:
$${arg {max}_{x}}_{Over PSS indices and multiple time hypotheses of data y} \frac{{\vert x * {y}_{1} \vert}^{2}}{{\vert \vert {y}_{1} \vert \vert}^{2} ( {y}_{1} * {y}_{1} - {\vert x * {y}_{1} \vert}^{2} )} + \frac{{\vert x * {y}_{2} \vert}^{2}}{{\vert \vert {y}_{2} \vert \vert}^{2} ( {y}_{2} * {y}_{2} - {\vert x * {y}_{2} \vert}^{2} )}$$

21. The apparatus of claim 18, comprising means to detect a primary synchronization signal (PSS) according to a timing hypothesis when received samples are correlated against a reference sequence, x, to determine a correlation peak indicative of a symbol boundary of the PSS, with normalization, according to the maximum, providing a detection rule, as follows:
$${arg {max}_{x}}_{Over PSS indices and multiple time hypotheses of data y} \frac{{\vert x * {y}_{1} \vert}^{2}}{{\vert \vert {y}_{1} \vert \vert}^{2}} + \frac{{\vert x * {y}_{2} \vert}^{2}}{{\vert \vert {y}_{2} \vert \vert}^{2}}$$

22. The apparatus of claim 18, comprising means to detect a primary synchronization signal (PSS) according to a timing hypothesis when received samples are correlated against a reference sequence, x, to determine a correlation peak indicative of a symbol boundary of the PSS, with normalization, according to the maximum, providing a detection rule, as follows:
$${arg {max}_{x}}_{Over PSS indices and multiple time hypotheses of data y} \frac{{\vert x * {y}_{1} \vert}^{2}}{{E}_{1}} + \frac{{\vert x * {y}_{2} \vert}^{2}}{{E}_{2}}$$

23. In a computer readable medium including computer readable instructions that may be utilized by one or more processors, the instructions comprising:
Instruction for employing frequency division duplexing (FDD) that may be synchronous or asynchronous for transmitting data, in which the underlying Rx signals have different statistics, and where the hypothesis testing is degraded thereby, the improvement comprising:
instructions for generating a complementary searcher metric that is a noise metric (NM); and
instructions for projecting the Rx signals into the noise subspace of a pilot sequence.

24. The computer readable medium of claim 23, wherein the noise metric (NM) is generated from the same set of Rx signal samples used to generate energy metrics (EM) to thereby share the same statistics.

25. The computer readable medium of claim 24, wherein the same statistics are gain scaling arising out of power variations in the Rx samples.

26. The computer readable medium of claim 24, wherein said complementary searcher metrics is the EM divided by the noise metric (NM) to effectively cancel out power variations and restore the accuracy of said hypothesis testing.

27. The computer readable medium of claim 24, wherein changes are made to said frequency division duplexing to enable said method to apply to a time division duplexing (TDD) mode that is synchronous, comprising:
normalizing the searcher metric using a timing detection algorithm to account for large power differences between the uplink (UL) and downlink (DL) transmissions.
